(19) United States
(12) Patent Application Publication
(10) Pub. No.: US 2025/0393087 A1
(43) Pub. Date: Dec. 25, 2025

(54) SELECTIVE ASSOCIATION FOR EXTENDED SINGLE MOBILITY DOMAIN NETWORKS

(71) Applicant: QUALCOMM Incorporated, San Diego, CA (US)

(72) Inventors: Ahmed Ragab ELSHERIF, San Jose, CA (US); George CHERIAN, San Diego, CA (US)

(21) Appl. No.: 18/748,065

(22) Filed: Jun. 19, 2024

(51) Int. Cl. H04W 76/15; H04L 5/00; H04W 8/02; H04W 48/06; H04W 88/08

(52) U.S. Cl. CPC H04W 76/15; H04L 5/0048; H04W 8/02; H04W 48/06; H04W 88/08

(57) ABSTRACT

This disclosure provides methods, components, devices and systems for selective association for extended single mobility domain (SMD) networks. Some aspects more specifically relate to signaling mechanisms according to which an access point (AP) may limit which stations (STAs) are able to roam to the AP in examples in which the AP is part of an SMD, which may be referred to as a multi-AP association. Such a limitation on which STAs are able to roam to the AP may be referred to as a selective association at the AP and, in some examples, the AP may transmit a frame that includes information indicative of the selective association at the AP. For example, the AP may transmit a frame that includes an information element indicative of the selective association at the AP. The information element may include an indication of one or more STAs allowed to associate with the AP.

### TECHNICAL FIELD

This disclosure relates generally to wireless communication and, more specifically, to selective association for extended single mobility domain (SMD) networks.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless communication device. The first wireless communication device may include a processing system that includes processor circuitry and memory circuitry that stores code. The processing system may be configured to cause the first wireless communication device to communicate a first set of frames associated with an establishment of a multi-access point (AP) association between the first wireless communication device and at least a second wireless communication device and transmit, in accordance with the establishment of the multi-AP association between the first wireless communication device and at least the second wireless communication device, a frame that includes an information element indicative of a selective association at the first wireless communication device, where the information element includes an indication of one or more stations (STAs) allowed to associate with the first wireless communication device.

Another innovative aspect of the subject matter described in this disclosure can be implemented in a method for wireless communication by or at a first wireless communication device. The method may include communicating a first set of frames associated with an establishment of a multi-AP association between the first wireless communication device and at least a second wireless communication device and transmitting, in accordance with the establishment of the multi-AP association between the first wireless communication device and at least the second wireless communication device, a frame that includes an information element indicative of a selective association at the first wireless communication device, where the information element includes an indication of one or more STAs allowed to associate with the first wireless communication device.

Another innovative aspect of the subject matter described in this disclosure can be implemented in a first wireless communication device. The first wireless communication device may include means for communicating a first set of frames associated with an establishment of a multi-AP association between the first wireless communication device and at least a second wireless communication device and means for transmitting, in accordance with the establishment of the multi-AP association between the first wireless communication device and at least the second wireless communication device, a frame that includes an information element indicative of a selective association at the first wireless communication device, where the information element includes an indication of one or more STAs allowed to associate with the first wireless communication device.

Another innovative aspect of the subject matter described in this disclosure can be implemented in a non-transitory computer-readable medium storing code for wireless communication by or at a first wireless communication device. The code may include instructions executable by a processing system to communicate a first set of frames associated with an establishment of a multi-AP association between the first wireless communication device and at least a second wireless communication device and transmit, in accordance with the establishment of the multi-AP association between the first wireless communication device and at least the second wireless communication device, a frame that includes an information element indicative of a selective association at the first wireless communication device, where the information element includes an indication of one or more STAs allowed to associate with the first wireless communication device.

In some implementations of the method, first wireless communication devices, and non-transitory computer-readable medium described herein, selectively associating with a set of station STAs in accordance with the selective association at the first wireless communication device, where the set of STAs includes at least a subset of the one or more STAs allowed to associate with the first wireless communication device.

In some implementations of the method, first wireless communication devices, and non-transitory computer-readable medium described herein, the information element includes an indication of whether the selective association at the first wireless communication device may be enabled or disabled and a set of the one or more STAs allowed to associate with the first wireless communication device may be associated with whether the selective association at the first wireless communication device may be enabled or disabled.

In some implementations of the method, first wireless communication devices, and non-transitory computer-readable medium described herein, the information element includes an indication of a quantity of the one or more STAs allowed to associate with the first wireless communication device.

In some implementations of the method, first wireless communication devices, and non-transitory computer-readable medium described herein, the information element includes a set of multiple fields and the set of multiple fields includes a first field that indicates whether the selective association at the first wireless communication device may be enabled or disabled; a second field that indicates a quantity of the one or more STAs allowed to associate with the first wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the first wireless communication device.

Some implementations of the method, first wireless communication devices, and non-transitory computer-readable medium described herein may further include operations, features, means, or instructions for receiving information indicative of the selective association at the first wireless communication device, where transmitting the frame that includes the information element indicative of the selective association at the first wireless communication device may be in accordance with receiving the information indicative of the selective association at the first wireless communication device.

Another innovative aspect of the subject matter described in this disclosure can be implemented in a first wireless communication device. The first wireless communication device may include a processing system that includes processor circuitry and memory circuitry that stores code. The processing system may be configured to cause the first wireless communication device to communicate a first set of frames associated with an establishment of a multi-AP association between the first wireless communication device and at least a second wireless communication device and receive, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device.

Another innovative aspect of the subject matter described in this disclosure can be implemented in a method for wireless communication by or at a first wireless communication device is described. The method may include communicating a first set of frames associated with an establishment of a multi-AP association between the first wireless communication device and at least a second wireless communication device and receiving, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device.

Another innovative aspect of the subject matter described in this disclosure can be implemented in a first wireless communication device. The first wireless communication device may include means for communicating a first set of frames associated with an establishment of a multi-AP association between the first wireless communication device and at least a second wireless communication device and means for receiving, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device.

Another innovative aspect of the subject matter described in this disclosure can be implemented in a non-transitory computer-readable medium storing code for wireless communication by or at a first wireless communication device. The code may include instructions executable by a processing system to communicate a first set of frames associated with an establishment of a multi-AP association between the first wireless communication device and at least a second wireless communication device and receive, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device.

In some implementations of the method, first wireless communication devices, and non-transitory computer-readable medium described herein, the information element includes a set of multiple fields and the set of multiple fields includes a first field that indicates whether the selective association at the second wireless communication device may be enabled or disabled; a second field that indicates a quantity of the one or more STAs allowed to associate with the second wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the second wireless communication device.

Some implementations of the method, first wireless communication devices, and non-transitory computer-readable medium described herein may further include operations, features, means, or instructions for transmitting, in accordance with receiving the frame, a second frame includes a second information element indicative of the selective association at the second wireless communication device, where the second information element includes the indication of the one or more STAs allowed to associate with the second wireless communication device.

Another innovative aspect of the subject matter described in this disclosure can be implemented in a STA. The STA may include a processing system that includes processor circuitry and memory circuitry that stores code. The processing system may be configured to cause the STA to receive a frame that includes an information element indicative of a selective association at a first AP, where the information element includes an indication of one or more STAs allowed to associate with the first AP, and selectively transmit a first set of frames to the first AP in accordance with the selective association at the first AP.

Another innovative aspect of the subject matter described in this disclosure can be implemented in a method for wireless communication by or at a STA. The method may include receiving a frame that includes an information element indicative of a selective association at a first AP, where the information element includes an indication of one or more STAs allowed to associate with the first AP, and selectively transmitting a first set of frames to the first AP in accordance with the selective association at the first AP.

Another innovative aspect of the subject matter described in this disclosure can be implemented in a STA. The STA may include means for receiving a frame that includes an information element indicative of a selective association at a first AP, where the information element includes an indication of one or more STAs allowed to associate with the first AP, and means for selectively transmitting a first set of frames to the first AP in accordance with the selective association at the first AP.

Another innovative aspect of the subject matter described in this disclosure can be implemented in a non-transitory computer-readable medium storing code for wireless communication by or at a STA. The code may include instructions executable by a processing system to receive a frame that includes an information element indicative of a selective association at a first AP, where the information element includes an indication of one or more STAs allowed to associate with the first AP, and selectively transmit a first set of frames to the first AP in accordance with the selective association at the first AP.

Some implementations of the method, STAs, and non-transitory computer-readable medium described herein may further include operations, features, means, or instructions for communicating a second set of frames in association with establishing one or more data paths between the STA and a single mobility domain (SMD) multi-link device (MLD) in accordance with the selective association at the first AP, where the SMD MLD may be associated with a set of multiple APs, and where the set of multiple APs includes the first AP in accordance with the one or more STAs allowed to associate with the first AP including the STA or excludes the first AP in accordance with the one or more STAs allowed to associate with the first AP excluding the STA.

In some implementations of the method, STAs, and non-transitory computer-readable medium described herein, the information element includes a set of multiple fields and the set of multiple fields includes a first field that indicates whether the selective association at the first AP may be enabled or disabled; a second field that indicates a quantity of the one or more STAs allowed to associate with the first AP; and a third field that includes one or more subfields, each subfield of the one or more subfields indicating a respective identifier of one or more identifiers, each identifier of the one or more identifiers corresponding to a respective STA of the one or more STAs allowed to associate with the first AP.

Another innovative aspect of the subject matter described in this disclosure can be implemented in a central controller. The central controller may include a processing system that includes processor circuitry and memory circuitry that stores code. The processing system may be configured to cause the central controller to establish a multi-AP association between at least a first wireless communication device and a second wireless communication device and transmit, in accordance with the establishment of the multi-AP association between at least the first wireless communication device and the second wireless communication device, information indicative of a selective association at the first wireless communication device, where the information includes an indication of one or more STAs allowed to associate with the first wireless communication device.

Another innovative aspect of the subject matter described in this disclosure can be implemented in a method for wireless communication by or at a central controller. The method may include establishing a multi-AP association between at least a first wireless communication device and a second wireless communication device and transmitting, in accordance with the establishment of the multi-AP association between at least the first wireless communication device and the second wireless communication device, information indicative of a selective association at the first wireless communication device, where the information includes an indication of one or more STAs allowed to associate with the first wireless communication device.

Another innovative aspect of the subject matter described in this disclosure can be implemented in a central controller. The central controller may include means for establishing a multi-AP association between at least a first wireless communication device and a second wireless communication device and means for transmitting, in accordance with the establishment of the multi-AP association between at least the first wireless communication device and the second wireless communication device, information indicative of a selective association at the first wireless communication device, where the information includes an indication of one or more STAs allowed to associate with the first wireless communication device.

Another innovative aspect of the subject matter described in this disclosure can be implemented in a non-transitory computer-readable medium storing code for wireless communication by or at a central controller. The code may include instructions executable by a processing system to establish a multi-AP association between at least a first wireless communication device and a second wireless communication device and transmit, in accordance with the establishment of the multi-AP association between at least the first wireless communication device and the second wireless communication device, information indicative of a selective association at the first wireless communication device, where the information includes an indication of one or more STAs allowed to associate with the first wireless communication device.

In some implementations of the method, central controllers, and non-transitory computer-readable medium described herein, the selective association at the first wireless communication device may be in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example network architecture that supports selective association for extended single mobility domain (SMD) networks.

FIG. 4 shows example network scenarios that support selective association for extended SMD networks.

FIG. 5 shows an example signaling diagram that supports selective association for extended SMD networks.

FIG. 6 shows an example process flow that supports selective association for extended SMD networks.

FIG. 7 shows a block diagram of an example wireless communication device that supports selective association for extended SMD networks.

FIG. 8 shows a block diagram of an example wireless communication device that supports selective association for extended SMD networks.

FIGS. 9 and 10 show flowcharts illustrating example processes performable by or at a first wireless communication device that supports selective association for extended SMD networks.

FIG. 11 shows a flowchart illustrating an example process performable by or at a station (STA) that supports selective association for extended SMD networks.

FIG. 12 shows a flowchart illustrating an example process performable by or at a central controller that supports selective association for extended SMD networks.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, multiple access points (APs) may establish a multi-AP association to facilitate seamless roaming at a station (STA), such as a client device, moving between APs of the multi-AP association. In other words, two or more APs may coordinate, communicate, or join or group with each other to facilitate seamless roaming at a STA between the two or more APs. Such a seamless roaming may refer to a handover (which may involve, for example, a data path switch or change) of a STA from a first AP to a second AP without a break in connection (such as without an association frame exchange between the STA and the second AP or without an interruption of a data transfer to or from the STA, among other examples). For example, each AP of a multi-AP association may store STA association information for a STA such that, after the STA associates with an AP of the multi-AP association, any AP of the multi-AP association may be able to provide a data path to the STA without performing another association procedure with the STA. A multi-AP association may be an example of, function as, or operate as a single mobility domain (SMD), such as an SMD multi-link device (MLD). For example, each AP associated with (such as a part of) a multi-AP association may provide or operate a respective set of links of the multi-AP association such that, collectively, APs belonging to a multi-AP association may effectively form an MLD (such as an MLD of non-collocated APs).

Some multi-AP associations provide seamless roaming for STAs without constraints on roaming. In other words, once a STA associates with an AP of a multi-AP association, the STA may expect all APs of the multi-AP association to be able to provide a data path to the STA. Such multi-AP associations may lack compatibility with or otherwise cause difficulties for some APs. For example, an AP may provide more seamless roaming for client devices of the AP by becoming part of a multi-AP association, but also may experience greater congestion, greater traffic loads, less restricted access, greater security risks, and greater power consumption by becoming part of the multi-AP association (as the AP may be expected to provide network access to any STA that happens to roam to the AP). Such a tradeoff for more seamless roaming may be net beneficial for some APs (such as infrastructure APs or APs that are generally available for public use) and may be incompatible with or otherwise cause difficulties for some other APs (such as mobile APs or APs deployed for a non-public use). For example, a non-AP STA operating as a mobile AP or an AP serving a secure location, such as a secure lab, may be unable or unwilling to join a multi-AP association without constraints on roaming due to concerns relating to congestion, traffic load, restricted access, security, or power consumption, which may adversely impact overall network efficiency. Thus, some networks may benefit from greater multi-AP association configurability to balance seamless roaming with other factors across various APs.

Various aspects relate generally to selective association at an AP, or any wireless communication device operating as an AP (such as a non-AP STA operating as a mobile AP), that is a member of or belongs to a multi-AP association (such as an SMD or an SMD MLD). Some aspects more specifically relate to one or more signaling mechanisms according to which an AP may limit which STAs of the multi-AP association are able to roam to the AP. In some examples, the AP may transmit a frame that includes an information element indicative of the selective association at the AP. Such an information element may include or indicate information pertaining to the selective association at the AP. For example, the information element may include an indication of one or more STAs allowed to associate with the AP. Additionally, or alternatively, the information element may include an indication of whether selective association at the AP is enabled or an indication of a quantity of the STAs allowed to associate with the AP. In some implementations, the information element may include a first field that indicates whether selective association at the AP is enabled or disabled, a second field that indicates the quantity of STAs allowed to associate with the AP, and a third field that identifies the STAs allowed to associate with the AP. Such a third field may include one or more subfields, with each subfield including an identifier that corresponds to (such as identifies) a respective STA. An identifier indicated by a subfield of the third field may, for example, be any identifier that uniquely identifies a STA or a group of STAs (such as a medium access control (MAC) address).

The AP may transmit (such as broadcast) the frame such that other APs of the multi-AP association or STAs in range of the AP receive the information pertaining to the selective association at the AP. In examples in which a second AP of the multi-AP association receives the frame, the second AP may parse the frame to acquire the information pertaining to the selective association at the AP and, in some implementations, may include such information in one or more frames that the second AP transmits (to relay or propagate the information throughout the network). In examples in which a STA receives the frame, the STA may parse the frame to acquire the information pertaining to the selective association at the AP and may selectively (such as conditionally) communicate with the AP in accordance with the information. For example, the STA may attempt to communicate with the AP if the STA is one of the STAs allowed to associate with the AP. Otherwise, the STA may refrain from attempting to communicate with the AP. In some implementations, the AP may define (such as set, configure, determine, identify, or select) the set of STAs allowed to associate with the AP. For example, a non-AP STA operating as a mobile AP (such as a phone, a laptop, or a gaming console) may define the set of STAs allowed to associate with the AP to include one or more client devices of the mobile AP (such as a glass, a headset, a controller, earbuds, or other peripheral devices). Additionally, or alternatively, a central controller (such as a device or entity controlling the multi-AP association) may define the set of STAs allowed to associate with the AP. In such implementations, the central controller may transmit (such as convey, provide, or indicate) the information pertaining to the selective association to the AP (for broadcasting by the AP).

Particular aspects of the subject matter described in this disclosure can be implemented to realize one or more of the following potential advantages. In some examples, by indicating the selective association at the AP via an information element of a transmitted (such as broadcasted) frame, the AP may efficiently inform various other wireless communication devices (such as one or more APs or one or more STAs, or any combination thereof) of the selective association at the AP. Further, by informing other wireless communication devices of the selective association at the AP, and in accordance with one or more configuration- or behavioral-based rules or mechanisms at the other wireless communication devices, the AP may expect the other wireless communication devices to comply with selective association at the AP. For example, if the AP indicates that a set of STAs are allowed to associate with the AP, APs of the multi-AP association may allow a STA of the set of STAs to roam to the AP with the selective association and may prohibit other STAs from roaming to the AP with the selective association, which may enable or facilitate restricted access to the AP with the selective association. Such a constraint on roaming to the AP with the selective association may protect the AP from high (such as more than a threshold amount of) congestion, traffic loads, security risks, and power consumption and still enable client devices of the AP to experience seamless roaming across the APs of the multi-AP association. In other words, the AP may support more informed or conditional discovery and provide greater mobility to client devices. Further, enabling or facilitating restrictive access to the AP with the selective association may enable some select authorized users (such as users or personnel working on a confidential project or in a restricted lab area for which the AP with the selective association provides network access) to seamlessly roam both to and from the AP with the selective association while restricting non-authorized users from roaming to the AP with the selective association. Moreover, by protecting the AP with the selective association from high congestion, traffic loads, security risks, and power consumption, the AP may provide higher data rates, greater quality of service, and lower latency, among other benefits, to the STAs allowed to roam to the AP. Additionally, by enabling the AP with the selective association to join or establish a multi-AP association, the overall network may experience greater spectral efficiency, greater network capacity, higher data rates, and greater connectivity, among other benefits, by facilitating more seamless roaming for at least a subset of STAs within the network.

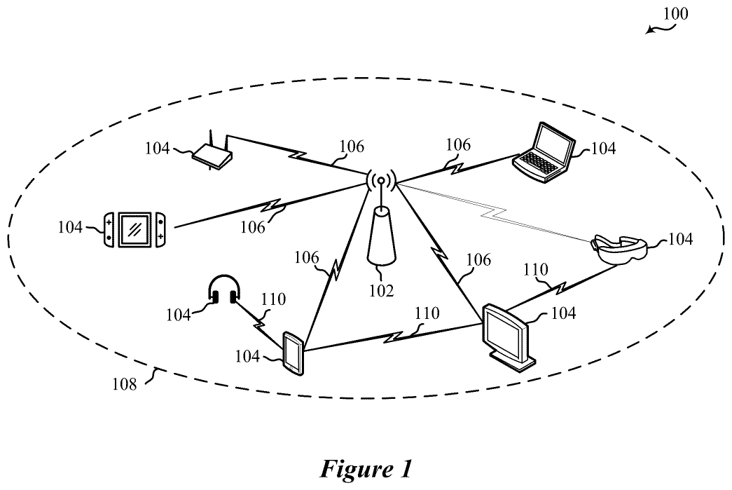

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, an SMD entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the example of a single BSS. For example, MLA may increase the quantity of users per multiplexed transmission served by the multi-link AP MLD.

In some wireless communication networks, such as the wireless communication network 100, two or more APs 102 may establish a multi-AP association (such as an SMD or an SMD MLD) to facilitate a more seamless roaming for STAs 104 across the APs 102 of the multi-AP association. Further, in some example implementations, one or more APs 102 of the multi-AP association may support a selective association. A selective association at an AP 102 may indicate or relate to how roaming to the AP 102 is selective, restricted, conditional, or constrained. For example, a selective association at an AP 102 may indicate that a set of STAs 104 are allowed to associate with the AP 102 and (implicitly or explicitly) indicate that other STAs 104 outside of the set of STAs 104 are not allowed to associate with the AP 102. In other words, a selective association at an AP 102 may indicate that a first set of STAs 104 are allowed to associate with the AP 102 or may indicate that a second set of STAs 104 are not allowed to associate with the AP 102, or any combination thereof.

An AP 102 may transmit (such as broadcast, such as via a management frame) information indicative of a selective association at the AP 102 to at least inform one or more other APs 102 of the multi-AP association of the selective association at the AP 102. In accordance with receiving the information indicative of the selective association at the AP 102, APs 102 of the multi-AP association may allow some STAs 104 to roam to the AP 102 and may prohibit some other STAs 104 from roaming to the AP 102 in accordance with the selective association. For example, one or more APs 102 or a central controller of the multi-AP association may set (such as update, configure, or switch) a data path between an application and a STA 104 to route through the AP 102 with the selective association in examples in which the STA 104 is allowed to associate with the AP 102. Otherwise, in examples in which the STA 104 is not allowed to associate with the AP 102, the one or more APs 102 or the central controller of the multi-AP association may refrain from setting the data path between the application and the STA 104 to route through the AP 102 with the selective association.

Further, in some implementations, other APs 102 of the multi-AP association may propagate the information indicative of the selective association at the AP 102 such that, for example, STAs 104 associated with or otherwise in range of any AP 102 of the multi-AP association may be informed of the selective association at the AP 102. Such STAs 104 may establish one or more candidate data paths or links to the multi-AP association in accordance with the selective association. For example, a STA 104 may include the AP 102 with the selective association as a candidate data path or link of the multi-AP association in examples in which the STA 104 is allowed to associate with the AP 102. Otherwise, the STA 104 may refrain from including the AP 102 with the selective association as a candidate data path or link of the multi-AP association.

In some aspects, a STA 104 that may selectively associate with the AP 102 may be a repeater or mesh node that is capable of connecting with the AP 102 as a client device and connecting with one or more other STAs 104 as an AP. In other words, such a STA 104 may have or operate in accordance with two functionalities including a first functionality of operating as a client device to the AP 102 with the selective association (which may be an example of or operate as a root AP) and a second functionality of operating as an AP to its own client devices. In such aspects, if the STA 104 is allowed to associate with the AP 102, the STA 104 may be a repeater or range extender for the AP 102 with the selective association. For example, the STA 104 may expand or extend the network access provided by the AP 102 with the selective association (in examples in which the STA 104 is allowed to associate with the AP 102).

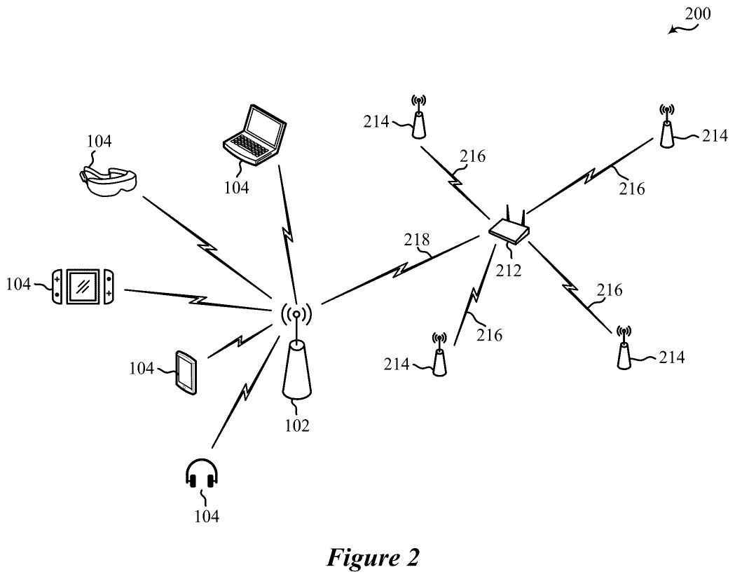

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 102, STAs 104, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some wireless communication networks, such as the wireless communication network 200, two or more APs 102 may establish a multi-AP association (such as an SMD or an SMD MLD) to facilitate a more seamless roaming for STAs 104 across the APs 102 of the multi-AP association. Further, in some example implementations, one or more APs 102 of the multi-AP association may support a selective association. An AP 102 may transmit (such as broadcast) information indicative of a selective association at the AP 102 to inform one or more other wireless communication devices within the wireless communication network 200 of the selective association at the AP 102. The AP 102 may transmit such information indicative of the selective association at the AP 102 via a frame, such as a management frame. For example, the frame may include one or more information elements (which may be equivalently referred to as “elements”), one or more fields, one or more subfields, or one or more bits that convey or provide the information indicative of the selective association at the AP 102.

For example, the frame may include an information element indicative of the selective association at the AP 102. Such an information element may include one or more fields or one or more subfields, or any combination thereof, to convey the information indicative of the selective association at the AP 102. In some implementations, the information element may include multiple fields, each field of the multiple fields conveying at least a portion of the information indicative of the selective association at the AP 102. For example, a first field of the information element may include an indication of whether selective association at the AP 102 is enabled or disabled, a second field of the information element may include an indication of a quantity of a set of STAs 104 allowed to associate with the AP 102, and a third field of the information element may include indications of STA identifiers corresponding to the set of STAs 104 allowed to associate with the AP 102.

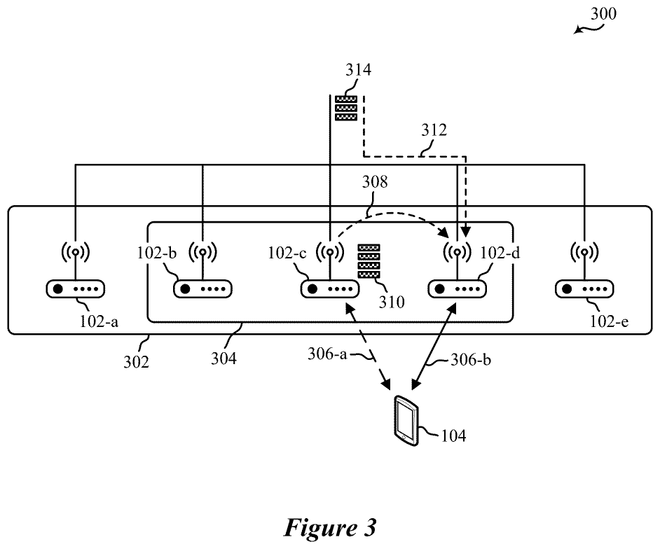

FIG. 3 shows an example network architecture 300 that supports selective association for extended SMD networks. In accordance with the network architecture 300, two or more APs 102 may associate with each other to form a multi-AP association 302. The multi-AP association 302 may be an example of, function as, or operate as an SMD, such as an SMD MLD. For example, each AP 102 associated with (such as a part of) the multi-AP association 302 may provide or operate a respective one or more links of the multi-AP association 302 such that, collectively, the APs 102 belonging to the multi-AP association 302 may effectively form an MLD. As illustrated in the example of the network architecture 300, the multi-AP association 302 may include an AP 102-a, an AP 102-b, an AP 102-c, and AP 102-d, and an AP 102-e. Further, although the multi-AP association 302 is illustrated as including five APs 102, a multi-AP association 302 may include any quantity of APs 102 without exceeding the scope of the present disclosure.

The multi-AP association 302 may support seamless roaming in scenarios in which a device, such as a STA 104, changes physical location (and moves across or between APs 102, such as across or between different coverage areas of different APs 102 of the multi-AP association 302). In other words, the multi-AP association 302 may provide or support a greater (such as more seamless) mobility experience and allow low-latency packet delivery across a network. Within the multi-AP association 302, an associated link set (ALS) 304 may denote or correspond to a subset of APs 102 (such as a subset of links of the multi-AP association 302) that have (such as store) STA association information. Such STA association information may include information indicative of an association identifier (AID) corresponding to a STA 104, a sequence number (SN) (such as a current SN or a SN space) corresponding to the STA 104, a pairwise transient key (PTK) associated with the STA 104, one or more block acknowledgment (BA) sessions associated with the STA 104, or any combination thereof.

In the example of the network architecture 300, the ALS 304 associated with the STA 104 may include the AP 102-b, the AP 102-c, and the AP 102-d. The STA 104 may switch between APs 102 within the ALS 304 associated with the STA 104. For example, the STA 104 may initially communicate (such as transmit or receive) data via a communication link 306-a between the AP 102-c and the STA 104 and may switch to communicating via a communication link 306-b between the AP 102-d and the STA 104. In such examples, the communication link 306-a may be understood as an “old” link and the communication link 306-b may be understood as a “new” link as the STA 104 roams toward the AP 102-d and away from the AP 102-c.

In accordance with switching from the communication link 306-a to the communication link 306-b, the AP 102-c and the AP 102-d may communicate one or more frames associated with a context or data transfer 308. The context or data transfer 308 may include a transfer of a context associated with the STA 104 from the AP 102-c to the AP 102-d, a transfer of one or more buffered data packets or data sessions associated with the STA 104 from the AP 102-c to the AP 102-d, or both. For example, as part of the context or data transfer 308, the AP 102-c may transfer one or more data packets associated with buffered data 310 at the AP 102-c to the AP 102-d. Alternatively, the AP 102-c may refrain from transferring the one or more data packets associated with the buffered data 310 and may transmit the one or more data packets associated with the buffered data 310 to the STA 104 via the communication link 306-a (prior to a termination of the communication link 306-a at the STA 104).

Further, one or more wireless communication devices (such as one or more APs 102, the STA 104, or a central controller) may update a data path 312 in association with the switching from the communication link 306-a to the communication link 306-b . For example, in association with the switching from the communication link 306-a to the communication link 306-b, one or more wireless communication devices may communicate one or more frames to establish (such as generate or construct) the data path 312 between the network and the STA 104. In accordance with establishing the data path 312, one or more wireless communication devices may route (such as transmit) new data 314 to or from the STA 104 via the AP 102-d.

In accordance with some example implementations, one or more of the APs 102 associated with the multi-AP association 302 may support a selective association. In accordance with supporting a selective association, an AP 102 may limit or restrict which STAs 104 are allowed to communicate with or via the AP 102. For example, in scenarios in which the AP 102-d supports a selective association, the AP 102-d may allow a first set of STAs 104 to associate and communicate with or via the AP 102-d and may prohibit a second set of STAs 104 from associating and communicating with or via the AP 102-d. In such examples, the AP 102-d may allow the STA 104 to roam to the AP 102-d if the STA 104 is within the first set of STAs 104 and may prohibit the STA 104 from roaming to the AP 102-d if the STA 104 is within the second set of STAs 104. In some implementations, the AP 102-d may transmit (such as broadcast) an indication of the first set of STAs 104 that are allowed to associate and communicate with the AP 102-d. In such implementations, the STA 104 may parse the indication of the first set of STAs 104 to determine (such as to obtain information indicating, to identify, or to ascertain) whether the STA 104 is within the first set of STAs 104. If the STA 104 is within the first set of STAs 104, the STA 104 may include the AP 102-d within the ALS 304 (and within the multi-AP association 302) known (such as stored) at the STA 104. If the STA 104 is not within the first set of STAs 104, the STA 104 may exclude the AP 102-d from the ALS 304 (and from the multi-AP association 302) known (such as stored) at the STA 104.

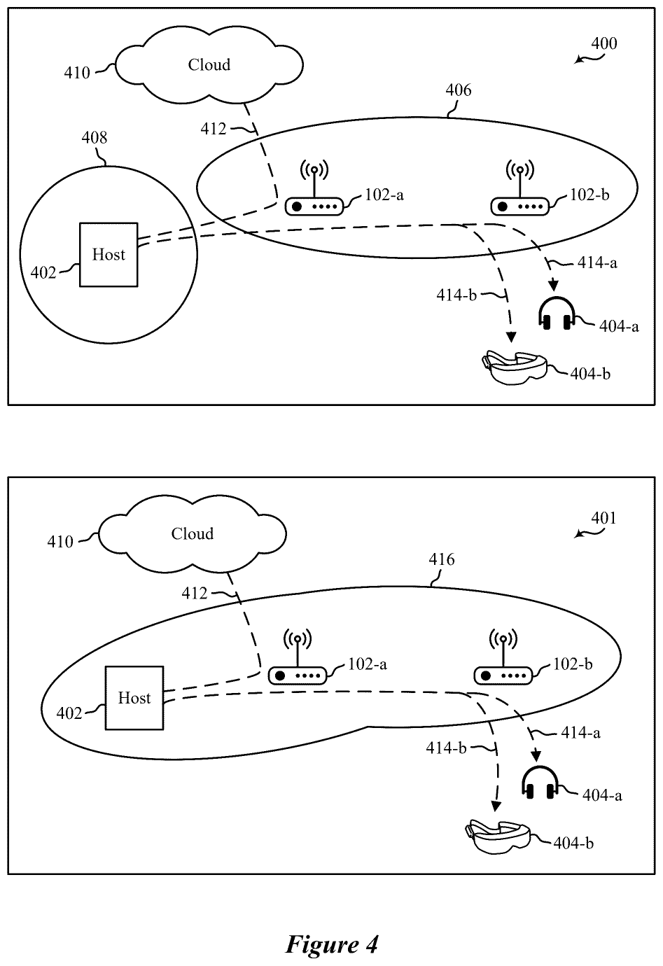

FIG. 4 shows example network scenarios 400 and 401 that support selective association for extended SMD networks. The network scenarios 400 and 401 illustrate scenarios in which one or more client devices roam away from a host device 402. For example, as illustrated in the network scenarios 400 and 401, a host device 402 (which may be more generally referred to herein as a wireless communication device) may transmit or receive data to or from a client device 404-a and a client device 404-b . The client device 404-a and the client device 404-b may be examples of STAs 104, such as the STAs 104 as illustrated by and described with reference to FIGS. 1-3. The host device 402 may be an example of any wireless communication device operating as an AP 102 with selective association.

For example, the host device 402 may be an example of another STA 104 and may, for example, operate as a mobile AP, such as a software-enabled AP (SAP), to serve (such as communicate with) the client device 404-a and the client device 404-b . For example, the host device 402 may communicate with the client device 404-a and the client device 404-b in accordance with a P2P use case. In such examples, the host device 402 may be a phone, a laptop, a gaming console, a vehicle, or any other device capable of wireless communications operating as a mobile hotspot or SAP and the client device 404-a and the client device 404-b may connect with the host device 402 instead of directly connecting with an AP 102, such as the AP 102-a or the AP 102-b . P2P use cases may include or be associated with an extended personal area network (XPAN) in which, for example, earbuds, a headset, wearables, gaming consoles, appliances, etc., may connect to a phone or laptop for greater connectivity. In some implementations, an XPAN may provide greater roaming capabilities and more robust data paths and, likewise, a greater user experience as compared to other communication protocols (such as a Bluetooth protocol). Additionally, or alternatively, P2P use cases may include or be associated with an augmented reality (AR), mixed reality (MR), extended reality (XR), or virtual reality (VR) applications in which a glass or head-mounted device (HMD) may connect to a phone or another communication device operating as a mobile hotspot or SAP.

In some scenarios, a client device (which may refer generally to one or both of the client device 404-a and the client device 404-b, and which may be an earbud, a headset, an AR/MR/XR/VR glass, a controller, or an HMD, among other examples) may roam away from the host device 402 (such as the phone, laptop, gaming console, or vehicle, among other examples). In such scenarios, to support an uninterrupted audio or video experience, the host device 402 may aim to provide a seamless roaming to an infrastructure AP 102 (in a home or enterprise deployment), such as the AP 102-a or the AP 102-b . In some scenarios (such as the network scenario 400), however, the AP 102-a and the AP 102-b may be associated with a multi-AP association 406 (such as an SMD) and the host device 402 may be associated with a standalone domain 408.

As compared to the multi-AP association 406, the standalone domain 408 may be associated with a different subnet and a locally managed dynamic host configuration protocol (DHCP) or domain name system (DNS). In such scenarios, any transition, roaming, or handover of a client device from the host device 402 to the AP 102-a or the AP 102-b may be associated with a “break-before-make” transition, which may fail to provide a seamless roaming. For example, a “break-before-make” transition may be associated with an audible noise at connection handover, a handover delay, or a relatively higher likelihood of a handover failure (as compared to, for example, a “make-before-break” transition). Thus, while the multi-AP association 406 may facilitate a seamless roaming between the AP 102-a and the AP 102-b, a handover to the AP 102-a or the AP 102-b from the host device 402 may not experience such seamless roaming.

In some implementations, and as illustrated by the network scenario 401, the host device 402, the AP 102-a, and the AP 102-b may support one or more signaling- or configuration-based mechanisms according to which the host device 402, the AP 102-a, and the AP 102-b may form a multi-AP association 416. Such a multi-AP association 416 may be understood or operate as an extended SMD, an extended SMD MLD, or a single MLD association. In other words, the host device 402, the AP 102-a, and the AP 102-b may support techniques to extend an SMD to include a mobile AP or SAP (such as a mobile hotspot) or any other wireless communication device operating as an AP 102 with selective association. In such implementations, the host device 402 (a mobile AP or an SAP, or any other wireless communication device operating as an AP 102 with selective association) may participate in an SMD or ALS as part of the multi-AP association 416. In some examples, the host device 402 may use a same internet protocol (IP) address with re-association in accordance with joining the multi-AP association 416. In such examples, the host device 402 may refrain from hosting a DHCP router and instead may rely on or use a DHCP router of an infrastructure AP 102 (such as a DHCP router of the AP 102-a or the AP 102-b ). In other words, the host device 402 may operate in an AP-only mode (instead of an AP +router mode) and may provide IP address continuity for devices associated with or belonging to the multi-AP association 416.

In some aspects, the multi-AP association 416 may support security and association context transfer (with some APs 102, such as UHR APs 102). In some other aspects, the multi-AP association 416 may support security, association, and data context transfer (with some APs 102, such as UHR APs 102). Data context transfer may include a transfer of information indicative of a BA session and a (current) packet number (PN), among other parameters associated with a (current) data session at a roaming client device. In accordance with such context transfers, the multi-AP association 416 may provide a seamless roaming throughout the extended SMD (such as across the host device 402, the AP 102-a, and the AP 102-b ) while facilitating backwards compatibility with some APs 102.

Additionally, in scenarios in which a client device roams or moves back to be within a coverage area of the host device 402, the client device may intend or expect to be handed over to the host device 402 (instead of remaining connected to an infrastructure AP 102). Such a priority to be handed over to the host device 402 in scenarios in which the client device is within the coverage area of the host device 402 may allow roaming devices (such as the client device) to have better wireless connections, save power, and have more efficient communication in examples in which the host device 402 and the client device are associated with a same vendor (such that the host device 402 and the client device may implement one or more proprietary or manufacturer- or vendor-specific P2P techniques). In some scenarios, however, the host device 402 may not allow all devices to roam to the host device 402. Instead, the host device 402 may allow a subset of devices (such as one or more specific devices) to roam to the host device 402 and may prohibit other devices from roaming to the host device 402 for one or more security, privacy, power consumption, congestion, latency, or load balancing reasons. For example, in an enterprise environment, a first user's phone enabling a wireless hotspot may not allow a second user's glass to roam to the phone of the first user. For further example, an AP 102 providing network access to a secure location, such as a secure lab, may allow authorized users or devices to roam to the AP 102 and may not allow unauthorized users or devices to roam to the AP 102.

In some implementations, the host device 402 may allow a subset of devices to roam to the host device 402 in accordance with supporting, enabling, or activating a selective association at the host device 402. For example, the host device 402 may be an AP 102 (or any device operating as an AP 102, such as a mobile AP or an SAP) with selective association such that one or more specific client devices are allowed to roam to the host device 402 and such that other client devices (such as other STAs 104) are not allowed to roam to the host device 402. In some aspects, if a client device is not allowed to roam to the host device 402, the host device 402 may not appear as part of an SMD or ALS of the client device. To indicate which client devices are allowed to roam to the host device 402, the host device 402 may indicate one or more unique identifiers, such as one or more MAC addresses, corresponding to the client device(s) that are allowed to roam to the host device 402. For example, if the client device 404-a and the client device 404-b are clients of the host device 402, the host device 402 may indicate that a first MAC address corresponding to the client device 404-a and that a second MAC address corresponding to the client device 404-b are allowed to roam to the host device 402.

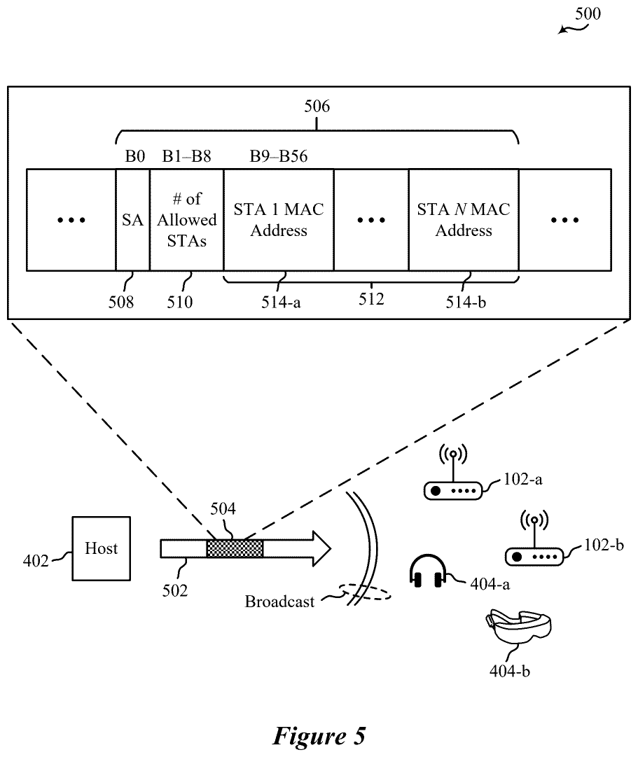

The host device 402 may indicate such unique identifying information via signaling, such as via one or more frames transmitted by the host device 402. For example, the host device 402 may include an information element, such as an SMD Selective Association information element, within one or more frames transmitted by the host device 402, with the information element including the unique identifying information of the client devices that are allowed to roam to the host device 402. In some implementations, the host device 402 may share (such as transmit or provide) the information element to one or both of the AP 102-a or the AP 102-b . Additionally, or alternatively, the host device 402 may broadcast the information element to a set of client devices. For example, the host device 402 may include the information element in one or more management frames of the host device 402, such as one or more beacon frames. Additional details relating to such a transmission of identifying information of the client devices that are allowed to roam to the host device 402 are illustrated by and described in more detail with reference to FIG. 5.

In accordance with the seamless roaming provided to the client device 404-a and the client device 404-b via the multi-AP association 416, the various wireless communication devices participating or otherwise involved in the multi-AP association 416 may support one or more of various traffic flows. For example, the multi-AP association 416 may support scenarios in which data to or from a roaming client device is originating from or destined to the host device 402 with selective association. Such scenarios in which the data is originating from or destined to the host device 402 may include scenarios in which a voice call is received on earbuds for a call originating from (such as received on) a (distant) phone, in which a voice call is initiated from the earbuds via a (distant) phone, or in which listening to a music stream is initiated from a phone (from a locally stored music library or streamed from the cloud) to the earbuds. In such examples, the host device 402 may communicate (such as transmit or receive) data with the client device 404-a or the client device 404-b via a communication link 414-a or a communication link 414-b, respectively (which may be examples of XPAN links). In implementations in which the client device 404-a and the client device 404-b are associated with the AP 102-b, the AP 102-a and the AP 102-b may operate or function as relay nodes between the host device 402 and the client device 404-a or the client device 404-b . Additionally, or alternatively, the host device 402 may communicate (such as transmit or receive) data with the cloud 410 (such as an application server) via a communication link 412.

For further example, the multi-AP association 416 may support scenarios in which data to or from a roaming client device is originating from or destined to a cloud 410 through an AP 102 that is currently associated with the roaming client device (which may be a device with selective association enabled or a device with selective association disabled). Such scenarios in which the data is originating from or destined to the cloud 410 may include video streaming, file downloads, or web browsing, among other examples, on a roaming AR/XR/MR/VR glass or HMD. In such examples, the client device 404-a or the client device 404-b may communicate with the cloud 410 (such as an application server) via one or more APs 102 (which may operate or function as relay nodes to the cloud 410).

Further, although selective association is illustrated and described in examples of mobile APs or SAPs, any wireless communication device (such as any AP 102) may employ, utilize, implement, or leverage selective association in accordance with the example implementations disclosed herein. For example, an infrastructure AP 102, such as the AP 102-a or the AP 102-b, may employ, enable, or activate selective association. A wireless communication device may employ selective association for one or more of various reasons, such as reasons of supporting pristine access or reasons of load balancing. A wireless communication device may employ selective association for pristine access in one or more of various scenarios, such as scenarios in which the wireless communication device operates within a hospital operation room, a secure lab, or in a game room with a clean channel for low latency. A wireless communication device may employ selective association for load balancing in one or more of various scenarios, such as scenarios in which enterprise APs 102 coordinate to allow a subset of client devices to roam across an entire SMD (which the APs 102 may use to balance a tradeoff between load balancing and seamless mobility across a larger area, such as for whole-home or whole-campus coverage).

Further, in some implementations, a wireless communication device may configure or define a selective association for itself or for another wireless communication device. For example, the host device 402 may configure or define the set of client devices (such as STAs 104) allowed to associate with the host device 402. Additionally, or alternatively, a central controller of the multi-AP association 416 may configure or define the set of client devices (such as STAs 104) allowed to associate with the host device 402. Such a central controller may be a device that controls, organizes, establishes, or maintains the multi-AP association 416. The central controller may be a separate (physical) device from the APs 102 of the multi-AP association 416 or may be a logical role, functionality, or entity assumed by an AP 102 of the multi-AP association 416. In other words, the central controller may be a physically separate device from the host device 402, the AP 102-a, and the AP 102-b or may be a logical role, functionality, or entity assumed by the host device 402, the AP 102-a, or the AP 102-b . In some implementations, the central controller may be a root AP 102.

FIG. 5 shows an example signaling diagram 500 that supports selective association for extended SMD networks. The signaling diagram 500 may implement or be implemented to realize one or more aspects of the wireless communication network 100, the wireless communication network 200, the network architecture 300, the network scenario 400, or the network scenario 401. For example, the signaling diagram 500 illustrates a transmission by a host device 402, which may be an example of the host device 402 as illustrated by and described with reference to FIG. 4. In some aspects, an AP 102-a, an AP 102-b, a client device 404-a, and a client device 404-b may receive the transmission by the host device 402. The AP 102-a of FIG. 5 may be an example of the AP 102-a as illustrated by and described with reference to FIG. 4, the AP 102-b of FIG. 5 may be an example of the AP 102-b as illustrated by and described with reference to FIG. 4, the client device 404-a of FIG. 5 may be an example of the client device 404-a as illustrated by and described with reference to FIG. 4, and the client device 404-b of FIG. 5 may be an example of the client device 404-b as illustrated by and described with reference to FIG. 4.

In some implementations, the host device 402 may transmit (such as broadcast or unicast), via a communication link 502, a frame 504 that includes an information element 506. The frame 504 may be a management frame, such as a beacon frame, or a data frame. The information element 506 may be an SMD Selective Association information element. In some implementations, the information element 506 may include information indicative of a set of client devices (such as a set of STAs 104) that are allowed to roam to the host device 402. The information element 506 may convey such information via one or more fields or one or more subfields, or any combination thereof. For example, the information element 506 may include a field 508, a field 510, and a field 512 (including, for example, a subfield 514-a and a subfield 514-b ).

In some examples, the field 508 may be a selective association field (illustrated as an “SA” field in the example of the signaling diagram 500). The field 508 may be an example of a 1-bit field and indicate whether selective association is enabled or disabled at the host device 402. For example, a first value of the field 508 (such as a “0” value) may indicate that all client devices are allowed to roam to the host device 402 (such that selective association is disabled). A second value of the field 508 (such as a “1” value) may indicate that not all client devices are allowed to roam to the host device 402 (such that selective association is enabled).

The field 510 may indicate a quantity of client devices that are allowed to roam to the host device 402. The field 510 may include any quantity of bits, such as any quantity of bits within an inclusive range of between 1 bit and 10 bits. Alternatively, the field 510 may include more than 10 bits (such as 11 bits or 12 bits, among other examples). In some examples, the field 510 may be an example of an 8-bit field. In such examples, the field 510 may indicate that up to 256 client devices are allowed to roam to the host device 402. The field 510 may be conditionally present in accordance with a value of the field 508. For example, if the field 508 indicates that selective association is disabled, the field 510 may be absent, reserved, or repurposed for indicating other information. Alternatively, if the field 508 indicates that selective association is enabled, the field 510 may be present.

The field 512 may include N subfields and each subfield may indicate a unique identifier corresponding to a client device that is allowed to roam to the host device 402. For example, each subfield of the field 512 may indicate a respective MAC address that corresponds to a client device that is allowed to roam to the host device 402. In such examples, an n^{th} subfield may indicate a MAC address of the n^{th} client device that is allowed to roam to the host device 402 transmitting the information element 506 or the host device 402 that is associated with the information element 506 (such that other devices may be able to propagate the information element 506 throughout a network in a manner according to which receiving devices are able to determine for which device the selective association applies). For example, the subfield 514-a may indicate a first MAC address corresponding to the client device 404-a and the subfield 514-b may indicate a second MAC address corresponding to the client device 404-b . In examples in which the field 512 indicates one or more MAC addresses, each subfield of the field 512 may be a 48-bit subfield. In such examples, the field 512 may include a quantity of N*48 bits.

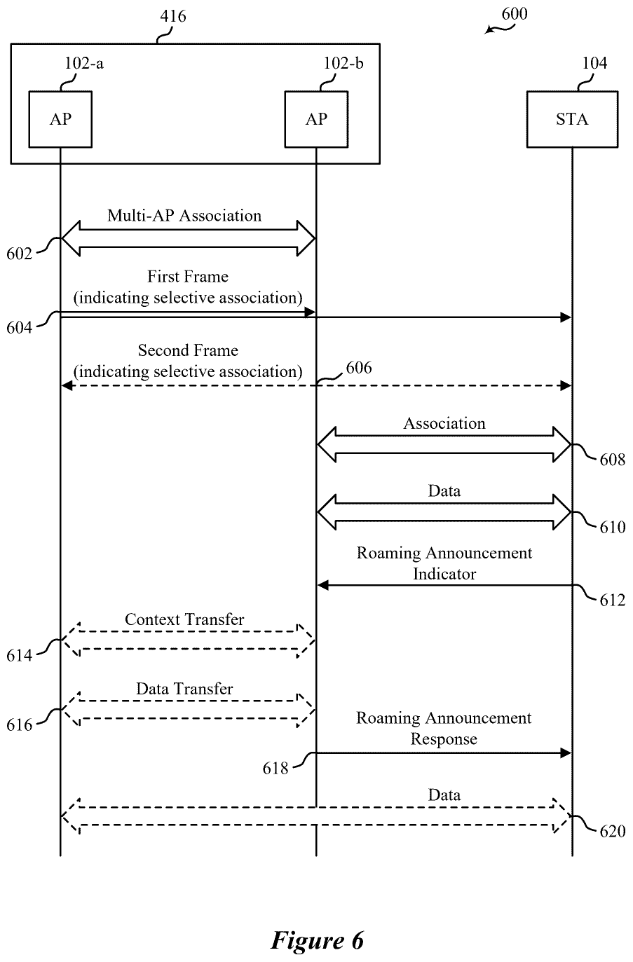

FIG. 6 shows an example process flow 600 that supports selective association for extended SMD networks. The process flow 600 may implement or be implemented to realize one or more aspects of wireless communication network 100, the wireless communication network 200, the network architecture 300, the network scenarios 400 and 401, or the signaling diagram 500. For example, the process flow 600 illustrates communication between an AP 102-a, an AP 102-b, and a STA 104. The AP 102-a and the AP 102-b may be examples of APs 102 as illustrated by and described with reference to FIGS. 1-5 and, more specifically, the AP 102-a may be an example of a host device 402 as illustrated by and described with reference to FIGS. 4 and 5 (or any other wireless communication device operating as an AP 102 with selective association). The STA 104 may be an example of a client device 404-a or a client device 404-b as illustrated by and described with reference to FIGS. 4 and 5 or a STA 104 as illustrated by and described with reference to FIGS. 1-3.

Alternative examples of the following may be implemented. Some steps are performed in a different order than described or are not performed at all. In some implementations, steps may include additional features not mentioned below, or further steps may be added. Further, although example devices are shown performing the operations of the process flow 600, some aspects of some operations also may be performed by one or more other wireless communication devices without exceeding the scope of the present disclosure.

At 602, the AP 102-a and the AP 102-b may exchange (such as communicate, such as transmit or receive, or any combination thereof) a first set of frames associated with establishing a multi-AP association 416 between the AP 102-a and the AP 102-b . Such a multi-AP association 416 may be an example of the multi-AP association 302 as illustrated by and described with reference to FIG. 3 or the multi-AP association 416 as illustrated by and described with reference to FIG. 4. For example, the multi-AP association 416 may be an example of an SMD or an SMD MLD. In some aspects, the multi-AP association 416 may be understood as an extended SMD, or an extended SMD MLD, by way of including the AP 102-a (a wireless communication device operating as an AP 102 with selective association).

At 604, the AP 102-a may transmit a first frame that includes information indicative of a selective association at the AP 102-a. Such a first frame may be an example of the frame 504 as illustrated by and described with reference to FIG. 5 and, in some implementations, may include an information element indicative of the selective association at the AP 102-a. For example, the information element may include an indication of one or more STAs 104 allowed to associate with the AP 102-a. In some aspects, the AP 102-a may broadcast the first frame. In accordance with the broadcasting of the first frame by the AP 102-a, the AP 102-b and the STA 104 may receive the first frame (and, likewise, the information indicative of the selective association at the AP 102-a). The AP 102-a may define the one or more STAs 104 allowed to associate with the AP 102-a or may receive information indicative of the one or more STAs 104 allowed to associate with the AP 102-a from a central controller of the multi-AP association 416.

At 606, the AP 102-b may, in some implementations, transmit a second frame that includes the information indicative of the selective association at the AP 102-a. In such implementations, the AP 102-b may relay or propagate the information indicative of the selective association at the AP 102-a by including the information indicative of the selective association at the AP 102-a in the second frame. The second frame may be an example of a management frame, such as a beacon frame, or a data frame transmitted (such as broadcasted) by the AP 102-b . In accordance with transmitting the second frame including the information indicative of the selective association at the AP 102-a, one or more STAs 104 associated with or otherwise in range of the AP 102-b may receive the information indicative of the selective association at the AP 102-a. The second frame may include an information element that includes the information indicative of the selective association at the AP 102-a. Further, the second frame, within the information element or another element, field, or subfield, may indicate that the information element (or the signaled information indicative of the selective association) is for or applicable to the AP 102-a (by including or indicating an identifier that corresponds to the AP 102-a).

At 608, the AP 102-b and the STA 104 may exchange (such as communicate, such as transmit or receive, or any combination thereof) a set of association frames. Such a set of association frames may include an association request frame transmitted by the STA 104 and an association response frame transmitted by the AP 102-b . In accordance with exchanging the set of association frames, the STA 104 may associate with the AP 102-b . Further, in accordance with associating with the AP 102, the STA 104 may establish one or more data paths between the STA 104 and the multi-AP association 416. Such data paths, which may be associated with links, may include a data path between the STA 104 and the AP 102-a in examples in which the STA 104 is allowed to associate with the AP 102-a (in accordance with the selective association at the AP 102-a). Otherwise, the data paths may exclude a data path between the STA 104 and the AP 102-a.

At 610, the STA 104 and the AP 102-b may exchange (such as communicate, such as transmit or receive, or any combination thereof) one or more data frames in accordance with the STA 104 associating with the AP 102-b . Such data frames may be associated with an application at or of the STA 104.

At 612, the STA 104 may transmit a roaming announcement indicator to the AP 102-b . The STA 104 may transmit the roaming announcement indicator to indicate, to the AP 102, an announcement, intention, expectation, or request to switch from the current data path between the STA 104 and the AP 102-b to a (new) data path between the STA 104 and the AP 102-a. In some examples, the STA 104 may transmit the roaming announcement indicator in accordance with a mobility of the STA 104, such as in accordance with the STA 104 moving closer to the AP 102-a or farther away from the AP 102, or both.

At 614, the AP 102-a and the AP 102-b may exchange (such as communicate, such as transmit or receive, or any combination thereof) a set of frames associated with a context transfer of the STA 104 from the AP 102-b to the AP 102-a. The AP 102-a and the AP 102-b may exchange the set of frames associated with the context transfer of the STA 104 in examples in which the STA 104 is allowed to associate with the AP 102-a (in accordance with the selective association at the AP 102-a).

At 616, the AP 102-a and the AP 102-b may exchange (such as communicate, such as transmit or receive, or any combination thereof) a set of frames associated with a data transfer (such as a data path switch) for the STA 104. For example, the AP 102-a and the AP 102-b may exchange the set of frames associated with the data transfer to switch (or supplement) the current data path between the STA 104 and the AP 102-b to (or with) a (new) data path between the STA 104 and the AP 102-a. The AP 102-a and the AP 102-b may exchange the set of frames associated with the data transfer for the STA 104 in examples in which the STA 104 is allowed to associate with the AP 102-a (in accordance with the selective association at the AP 102-a).

At 618, the AP 102-b may transmit a roaming announcement response to the STA 104. For example, the AP 102-b may transmit the roaming announcement response to the STA 104 to provide a response to the roaming announcement indicator transmitted by the STA 104. In some examples, the roaming announcement response may indicate an approval or confirmation of a roaming of the STA 104 from the AP 102-b to the AP 102-a. In some other examples, the roaming announcement response may indicate a rejection or denial of the roaming of the STA 104 from the AP 102-b to the AP 102-a. The indication provided by the roaming announcement response may, in some examples, be in accordance with the selective association at the AP 102-a.

At 620, in examples in which the roaming announcement response approves or confirms the roaming of the STA 104 from the AP 102-b to the AP 102-a, the STA 104 and the AP 102-a may exchange (such as communicate, such as transmit or receive, or any combination thereof) one or more data frames. Such data frames may be associated with an application at or of the STA 104. Further, the STA 104 and the AP 102-a may exchange the one or more data frames without performing an association frame exchange in accordance with the AP 102-b and the AP 102-a being members of the multi-AP association 416. For example, the STA 104 may have previously “associated” with the AP 102-a in accordance with associating with the AP 102-b and in accordance with the STA 104 being allowed to associate with the AP 102-a (in accordance with the selective association at the AP 102-a).

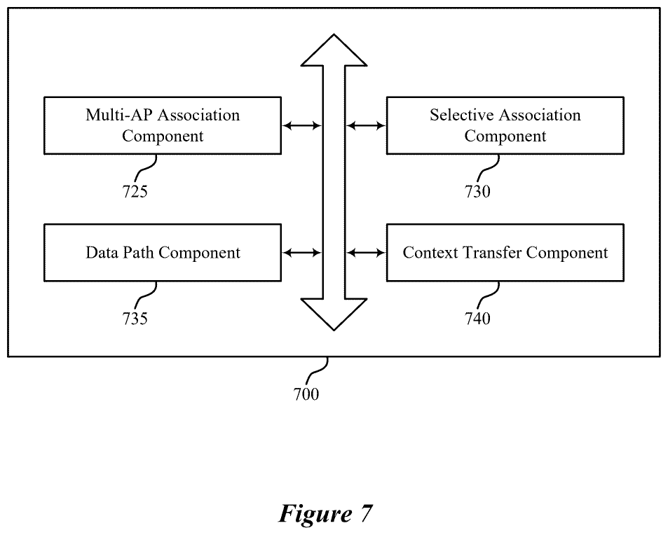

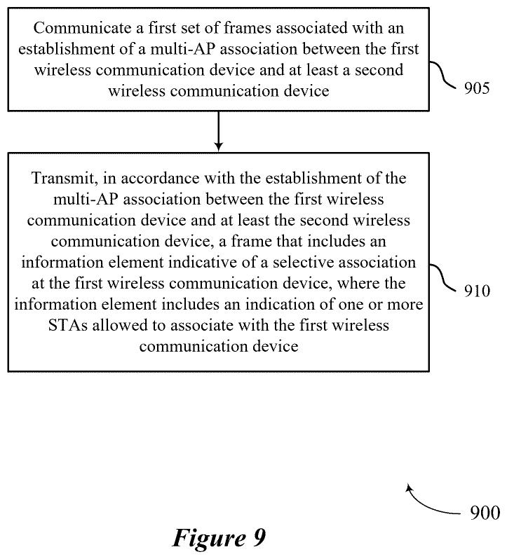

FIG. 7 shows a block diagram of an example wireless communication device 700 that supports selective association for extended SMD networks. In some examples, the wireless communication device 700 is configured to perform the processes 900, 1000, and 1200 described with reference to FIGS. 9, 10, and 12, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein.

Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP or in a non-AP STA operating as an AP (such as the AP 102 described with reference to FIG. 1) or in a central controller. In some other examples, the wireless communication device 700 can be an AP, a non-AP STA operating as an AP, or a central controller that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a multi-AP association component 725, a selective association component 730, a data path component 735, and a context transfer component 740. Portions of one or more of the multi-AP association component 725, the selective association component 730, the data path component 735, and the context transfer component 740 may be implemented at least in part in hardware or firmware. For example, one or more of the multi-AP association component 725, the selective association component 730, the data path component 735, and the context transfer component 740 may be implemented at least in part by at least a processor or a modem. In some examples, portions of one or more of the multi-AP association component 725, the selective association component 730, the data path component 735, and the context transfer component 740 may be implemented at least in part by a processor and software in the form of processor-executable code stored in memory.

The wireless communication device 700 may support wireless communication in accordance with examples as disclosed herein. The multi-AP association component 725 is configurable or configured to communicate a first set of frames associated with an establishment of a multi-AP association between the first wireless communication device and at least a second wireless communication device. The selective association component 730 is configurable or configured to transmit, in accordance with the establishment of the multi-AP association between the first wireless communication device and at least the second wireless communication device, a frame that includes an information element indicative of a selective association at the first wireless communication device, where the information element includes an indication of one or more STAs allowed to associate with the first wireless communication device.

In some examples, the selective association component 730 is configurable or configured to selectively (such as conditionally) associate with a set of STAs in accordance with the selective association at the first wireless communication device, where the set of STAs includes at least a subset of the one or more STAs allowed to associate with the first wireless communication device.

In some examples, the information element includes an indication of whether the selective association at the first wireless communication device is enabled or disabled. In some examples, a set of the one or more STAs allowed to associate with the first wireless communication device is associated with whether the selective association at the first wireless communication device is enabled or disabled.

In some examples, the information element includes an indication of a quantity of the one or more STAs allowed to associate with the first wireless communication device.

In some examples, the information element includes a set of multiple fields. In some examples, the set of multiple fields includes a first field that indicates whether the selective association at the first wireless communication device is enabled or disabled; a second field that indicates a quantity of the one or more STAs allowed to associate with the first wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the first wireless communication device.

In some examples, the first field includes a first quantity of bits that indicate whether the selective association at the first wireless communication device is enabled or disabled; the second field includes a second quantity of bits that indicate the quantity of the one or more STAs allowed to associate with the first wireless communication device; and each subfield of the one or more subfields within the third field includes a third quantity of bits that indicate the respective identifier of one or more identifiers.

In some examples, the first quantity of bits is one bit; the second quantity of bits is within an inclusive range of one bit and ten bits; and the third quantity of bits is 48 bits.

In some examples, the selective association component 730 is configurable or configured to receive information indicative of the selective association at the first wireless communication device, where transmitting the frame that includes the information element indicative of the selective association at the first wireless communication device is in accordance with receiving the information indicative of the selective association at the first wireless communication device.

In some examples, the information indicative of the selective association at the first wireless communication device is received from a central controller of the multi-AP association.

In some examples, the data path component 735 is configurable or configured to communicate a second set of frames in association with switching a first data path between a STA and the second wireless communication device to a second data path between the STA and the first wireless communication device in accordance with the selective association at the first wireless communication device.

In some examples, the context transfer component 740 is configurable or configured to communicate a third set of frames associated with a context transfer of the STA from the second wireless communication device to the first wireless communication device in accordance with the selective association at the first wireless communication device, where communicating the second set of frames is in accordance with communicating the third set of frames associated with the context transfer.

In some examples, communicating one or both of the second set of frames and the third set of frames is in association with the one or more STAs allowed to associate with the first wireless communication device including the STA.

In some examples, the first wireless communication device prohibits a switching from a first data path between a STA and the second wireless communication device to a second data path between the STA and the first wireless communication device in accordance with the selective association at the first wireless communication device.

In some examples, the first wireless communication device prohibits the switching from the first data path to the second data path in association with the one or more STAs allowed to associate with the first wireless communication device excluding the STA.

In some examples, the selective association at the first wireless communication device is in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.

In some examples, each of the first wireless communication device and the second wireless communication device is associated with a respective set of links of an SMD MLD in accordance with the multi-AP association between the first wireless communication device and the second wireless communication device. In some examples, the frame is a management frame. In some examples, the management frame is a beacon frame.

Additionally, or alternatively, the wireless communication device 700 may support wireless communication in accordance with examples as disclosed herein. In some examples, the multi-AP association component 725 is configurable or configured to communicate a first set of frames associated with an establishment of a multi-AP association between the first wireless communication device and at least a second wireless communication device. In some examples, the selective association component 730 is configurable or configured to receive, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device.

In some examples, the information element includes an indication of whether the selective association at the second wireless communication device is enabled or disabled. In some examples, a set of the one or more STAs allowed to associate with the second wireless communication device is associated with whether the selective association at the second wireless communication device is enabled or disabled.

In some examples, the information element includes an indication of a quantity of the one or more STAs allowed to associate with the second wireless communication device.

In some examples, the information element includes a set of multiple fields. In some examples, the set of multiple fields includes a first field that indicates whether the selective association at the second wireless communication device is enabled or disabled; a second field that indicates a quantity of the one or more STAs allowed to associate with the second wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the second wireless communication device.

In some examples, the first field includes a first quantity of bits that indicates whether the selective association at the second wireless communication device is enabled or disabled; the second field includes a second quantity of bits that indicates the quantity of the one or more STAs allowed to associate with the second wireless communication device; and each subfield of the one or more subfields within the third field includes a third quantity of bits that indicates the respective identifier of one or more identifiers.

In some examples, the first quantity of bits is one bit; the second quantity of bits is within an inclusive range of one bit and ten bits; and the third quantity of bits is 48 bits.

In some examples, the selective association component 730 is configurable or configured to transmit, in accordance with receiving the frame, a second frame includes a second information element indicative of the selective association at the second wireless communication device, where the second information element includes the indication of the one or more STAs allowed to associate with the second wireless communication device.

In some examples, the frame that includes the information element indicative of the selective association at the second wireless communication device is received from the second wireless communication device or a central controller of the multi-AP association.

In some examples, the data path component 735 is configurable or configured to communicate a second set of frames in association with switching a first data path between a STA and the first wireless communication device to a second data path between the STA and the second wireless communication device in accordance with the selective association at the second wireless communication device.

In some examples, the context transfer component 740 is configurable or configured to communicate a third set of frames associated with a context transfer of the STA from the first wireless communication device to the second wireless communication device in accordance with the selective association at the second wireless communication device, where communicating the second set of frames is in accordance with communicating the third set of frames associated with the context transfer.

In some examples, communicating one or both of the second set of frames and the third set of frames is in association with the one or more STAs allowed to associate with the second wireless communication device including the STA.

In some examples, the selective association at the second wireless communication device is in accordance with the second wireless communication device operating as a mobile AP, a traffic load restriction at the second wireless communication device, a traffic type restriction at the second wireless communication device, a client type restriction at the second wireless communication device, a user restriction at the second wireless communication device, or any combination thereof.

In some examples, each of the first wireless communication device and the second wireless communication device is associated with a respective set of links of an SMD MLD in accordance with the multi-AP association between the first wireless communication device and the second wireless communication device. In some examples, the frame is a management frame. In some examples, the management frame is a beacon frame.

Additionally, or alternatively, the wireless communication device 700 may support wireless communication in accordance with examples as disclosed herein. In some examples, the multi-AP association component 725 is configurable or configured to establish a multi-AP association between at least a first wireless communication device and a second wireless communication device. In some examples, the selective association component 730 is configurable or configured to transmit, in accordance with the establishment of the multi-AP association between at least the first wireless communication device and the second wireless communication device, information indicative of a selective association at the first wireless communication device, where the information includes an indication of one or more STAs allowed to associate with the first wireless communication device.

In some examples, the selective association at the first wireless communication device is in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.

In some examples, each of the first wireless communication device and the second wireless communication device is associated with a respective set of links of an SMD MLD in accordance with the multi-AP association between the first wireless communication device and the second wireless communication device.

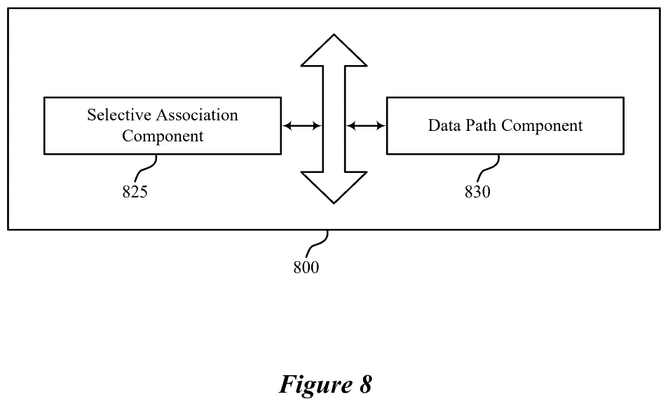

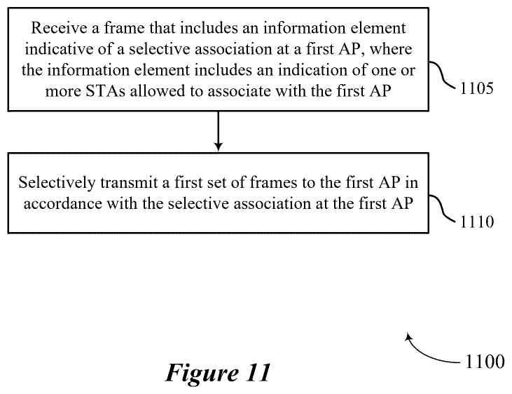

FIG. 8 shows a block diagram of an example wireless communication device 800 that supports selective association for extended SMD networks. In some examples, the wireless communication device 800 is configured to perform the process 1100 described with reference to FIG. 11. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein.

Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in a STA, such as the STA 104 described with reference to FIG. 1. In some other examples, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes a user interface (UI) (such as a touchscreen or keypad) and a display, which may be integrated with the UI to form a touchscreen display that is coupled with the processing system. In some examples, the wireless communication device 800 may further include one or more sensors such as, for example, one or more inertial sensors, accelerometers, temperature sensors, pressure sensors, or altitude sensors, that are coupled with the processing system.

The wireless communication device 800 includes a selective association component 825 and a data path component 830. Portions of one or more of the selective association component 825 and the data path component 830 may be implemented at least in part in hardware or firmware. For example, one or more of the selective association component 825 and the data path component 830 may be implemented at least in part by at least a processor or a modem. In some examples, portions of one or more of the selective association component 825 and the data path component 830 may be implemented at least in part by a processor and software in the form of processor-executable code stored in memory.

The wireless communication device 800 may support wireless communication in accordance with examples as disclosed herein. The selective association component 825 is configurable or configured to receive a frame that includes an information element indicative of a selective association at a first AP, where the information element includes an indication of one or more STAs allowed to associate with the first AP. In some examples, the selective association component 825 is configurable or configured to selectively (such as conditionally) transmit a first set of frames to the first AP in accordance with the selective association at the first AP.

In some examples, the data path component 830 is configurable or configured to communicate a second set of frames in association with establishing one or more data paths between the STA and an SMD MLD in accordance with the selective association at the first AP, where the SMD MLD is associated with a set of multiple APs, and where the set of multiple APs includes the first AP in accordance with the one or more STAs allowed to associate with the first AP including the STA; or excludes the first AP in accordance with the one or more STAs allowed to associate with the first AP excluding the STA.

In some examples, the information element includes an indication of whether the selective association at the first AP is enabled or disabled. In some examples, a set of the one or more STAs allowed to associate with the first AP is associated with whether the selective association at the first AP is enabled or disabled.

In some examples, the information element includes an indication of a quantity of the one or more STAs allowed to associate with the first AP.

In some examples, the information element includes a set of multiple fields. In some examples, the set of multiple fields includes a first field that indicates whether the selective association at the first AP is enabled or disabled; a second field that indicates a quantity of the one or more STAs allowed to associate with the first AP; and a third field that includes one or more subfields, each subfield of the one or more subfields indicating a respective identifier of one or more identifiers, each identifier of the one or more identifiers corresponding to a respective STA of the one or more STAs allowed to associate with the first AP.

In some examples, the first field includes a first quantity of bits that indicate whether the selective association at the first AP is enabled or disabled; the second field includes a second quantity of bits that indicates the quantity of the one or more STAs allowed to associate with the first AP; and each subfield of the one or more subfields within the third field includes a third quantity of bits that indicates the respective identifier of one or more identifiers.

In some examples, the first quantity of bits is one bit; the second quantity of bits is within an inclusive range of one bit and ten bits; and the third quantity of bits is 48 bits.

In some examples, to support selectively transmitting the first set of frames to the first AP, the selective association component 825 is configurable or configured to transmit the first set of frames in accordance with the one or more STAs allowed to associate with the first AP including the STA. In some examples, to support selectively transmitting the first set of frames to the first AP, the selective association component 825 is configurable or configured to refrain from transmitting the first set of frames in accordance with the one or more STAs allowed to associate with the first AP excluding the STA. In some examples, the first set of frames includes an association frame, a probe request frame, a data frame, or any combination thereof.

In some examples, the selective association at the first AP is in accordance with the first AP operating as a mobile AP, a traffic load restriction at the first AP, a traffic type restriction at the first AP, a client type restriction at the first AP, a user restriction at the first AP, or any combination thereof. In some examples, the frame is a management frame. In some examples, the management frame is a beacon frame.

FIG. 9 shows a flowchart illustrating an example process 900 performable by or at a first wireless communication device that supports selective association for extended SMD networks. The operations of the process 900 may be implemented by a first wireless communication device or its components as described herein. For example, the process 900 may be performed by a wireless communication device, such as the wireless communication device 700 described with reference to FIG. 7, operating as or within a wireless AP or a non-AP STA that operates as a wireless AP, such as a mobile AP or SAP. In some examples, the process 900 may be performed by a wireless AP, such as one of the APs 102 described with reference to FIG. 1.

In some examples, in 905, the first wireless communication device may communicate a first set of frames associated with an establishment of a multi-AP association between the first wireless communication device and at least a second wireless communication device. The operations of 905 may be performed in accordance with examples as disclosed herein. In some implementations, aspects of the operations of 905 may be performed by a multi-AP association component 725 as described with reference to FIG. 7.

In some examples, in 910, the first wireless communication device may transmit, in accordance with the establishment of the multi-AP association between the first wireless communication device and at least the second wireless communication device, a frame that includes an information element indicative of a selective association at the first wireless communication device, where the information element includes an indication of one or more STAs allowed to associate with the first wireless communication device. The operations of 910 may be performed in accordance with examples as disclosed herein. In some implementations, aspects of the operations of 910 may be performed by a selective association component 730 as described with reference to FIG. 7.

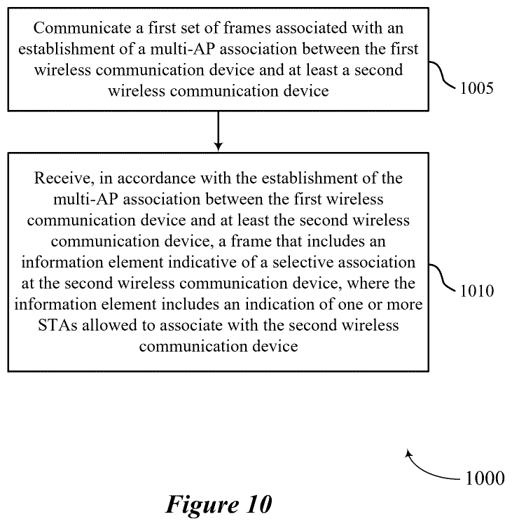

FIG. 10 shows a flowchart illustrating an example process 1000 performable by or at a first wireless communication device that supports selective association for extended SMD networks. The operations of the process 1000 may be implemented by a first wireless communication device or its components as described herein. For example, the process 1000 may be performed by a wireless communication device, such as the wireless communication device 700 described with reference to FIG. 7, operating as or within a wireless AP. In some examples, the process 1000 may be performed by a wireless AP, such as one of the APs 102 described with reference to FIG. 1.

In some examples, in 1005, the first wireless communication device may communicate a first set of frames associated with an establishment of a multi-AP association between the first wireless communication device and at least a second wireless communication device. The operations of 1005 may be performed in accordance with examples as disclosed herein. In some implementations, aspects of the operations of 1005 may be performed by a multi-AP association component 725 as described with reference to FIG. 7.

In some examples, in 1010, the first wireless communication device may receive, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device. The operations of 1010 may be performed in accordance with examples as disclosed herein. In some implementations, aspects of the operations of 1010 may be performed by a selective association component 730 as described with reference to FIG. 7.

FIG. 11 shows a flowchart illustrating an example process 1100 performable by or at a STA that supports selective association for extended SMD networks. The operations of the process 1100 may be implemented by a STA or its components as described herein. For example, the process 1100 may be performed by a wireless communication device, such as the wireless communication device 800 described with reference to FIG. 8, operating as or within a wireless STA. In some examples, the process 1100 may be performed by a wireless STA, such as one of the STAs 104 described with reference to FIG. 1.

In some examples, in 1105, the STA may receive a frame that includes an information element indicative of a selective association at a first AP, where the information element includes an indication of one or more STAs allowed to associate with the first AP. The operations of 1105 may be performed in accordance with examples as disclosed herein. In some implementations, aspects of the operations of 1105 may be performed by a selective association component 825 as described with reference to FIG. 8.

In some examples, in 1110, the STA may selectively transmit a first set of frames to the first AP in accordance with the selective association at the first AP. The operations of 1110 may be performed in accordance with examples as disclosed herein. In some implementations, aspects of the operations of 1110 may be performed by a selective association component 825 as described with reference to FIG. 8.

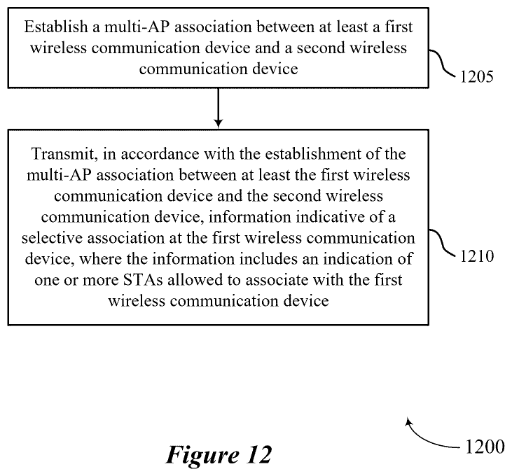

FIG. 12 shows a flowchart illustrating an example process 1200 performable by or at a central controller that supports selective association for extended SMD networks. The operations of the process 1200 may be implemented by a central controller or its components as described herein. For example, the process 1200 may be performed by a wireless communication device, such as the wireless communication device 700 described with reference to FIG. 7, operating as or within a central controller or a wireless AP. In some examples, the process 1200 may be performed by a central controller or a wireless AP, such as one of the APs 102 described with reference to FIG. 1.

In some examples, in 1205, the central controller may establish a multi-AP association between at least a first wireless communication device and a second wireless communication device. The operations of 1205 may be performed in accordance with examples as disclosed herein. In some implementations, aspects of the operations of 1205 may be performed by a multi-AP association component 725 as described with reference to FIG. 7.

In some examples, in 1210, the central controller may transmit, in accordance with the establishment of the multi-AP association between at least the first wireless communication device and the second wireless communication device, information indicative of a selective association at the first wireless communication device, where the information includes an indication of one or more STAs allowed to associate with the first wireless communication device. The operations of 1210 may be performed in accordance with examples as disclosed herein. In some implementations, aspects of the operations of 1210 may be performed by a selective association component 730 as described with reference to FIG. 7.

Implementation examples are described in the following numbered clauses:
Clause 1: A method for wireless communication at a first wireless communication device, including: communicating a first set of frames associated with an establishment of a multi-AP association between the first wireless communication device and at least a second wireless communication device; and transmitting, in accordance with the establishment of the multi-AP association between the first wireless communication device and at least the second wireless communication device, a frame that includes an information element indicative of a selective association at the first wireless communication device, where the information element includes an indication of one or more STAs allowed to associate with the first wireless communication device.
Clause 2: The method of clause 1, further including: selectively associating with a set of STAs in accordance with the selective association at the first wireless communication device, where the set of STAs includes at least a subset of the one or more STAs allowed to associate with the first wireless communication device.
Clause 3: The method of any of clauses 1-2, where the information element includes an indication of whether the selective association at the first wireless communication device is enabled or disabled, and a set of the one or more STAs allowed to associate with the first wireless communication device is associated with whether the selective association at the first wireless communication device is enabled or disabled.
Clause 4: The method of any of clauses 1-3, where the information element includes an indication of a quantity of the one or more STAs allowed to associate with the first wireless communication device.
Clause 5: The method of any of clauses 1-4, where the information element includes a set of multiple fields, and the set of multiple fields includes a first field that indicates whether the selective association at the first wireless communication device is enabled or disabled; a second field that indicates a quantity of the one or more STAs allowed to associate with the first wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the first wireless communication device.
Clause 6: The method of clause 5, where the first field includes a first quantity of bits that indicate whether the selective association at the first wireless communication device is enabled or disabled; the second field includes a second quantity of bits that indicate the quantity of the one or more STAs allowed to associate with the first wireless communication device; and each subfield of the one or more subfields within the third field includes a third quantity of bits that indicate the respective identifier of one or more identifiers.
Clause 7: The method of clause 6, where the first quantity of bits is one bit; the second quantity of bits is within an inclusive range of one bit and ten bits; and the third quantity of bits is 48 bits.
Clause 8: The method of any of clauses 1-7, further including: receiving information indicative of the selective association at the first wireless communication device, where transmitting the frame that includes the information element indicative of the selective association at the first wireless communication device is in accordance with receiving the information indicative of the selective association at the first wireless communication device.
Clause 9: The method of clause 8, where the information indicative of the selective association at the first wireless communication device is received from a central controller of the multi-AP association.
Clause 10: The method of any of clauses 1-9, further including: communicating a second set of frames in association with switching a first data path between a STA and the second wireless communication device to a second data path between the STA and the first wireless communication device in accordance with the selective association at the first wireless communication device.
Clause 11: The method of clause 10, further including: communicating a third set of frames associated with a context transfer of the STA from the second wireless communication device to the first wireless communication device in accordance with the selective association at the first wireless communication device, where communicating the second set of frames is in accordance with communicating the third set of frames associated with the context transfer.
Clause 12: The method of clause 11, where communicating one or both of the second set of frames and the third set of frames is in association with the one or more STAs allowed to associate with the first wireless communication device including the STA.
Clause 13: The method of any of clauses 1-12, where the first wireless communication device prohibits a switching from a first data path between a STA and the second wireless communication device to a second data path between the STA and the first wireless communication device in accordance with the selective association at the first wireless communication device.
Clause 14: The method of clause 13, where the first wireless communication device prohibits the switching from the first data path to the second data path in association with the one or more STAs allowed to associate with the first wireless communication device excluding the STA.
Clause 15: The method of any of clauses 1-14, where the selective association at the first wireless communication device is in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.
Clause 16: The method of any of clauses 1-15, where each of the first wireless communication device and the second wireless communication device is associated with a respective set of links of an SMD MLD in accordance with the multi-AP association between the first wireless communication device and the second wireless communication device.
Clause 17: The method of any of clauses 1-16, where the frame is a management frame.
Clause 18: The method of clause 17, where the management frame is a beacon frame.
Clause 19: A method for wireless communication at a first wireless communication device, including: communicating a first set of frames associated with an establishment of a multi-AP association between the first wireless communication device and at least a second wireless communication device; and receiving, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device.
Clause 20: The method of clause 19, where the information element includes an indication of whether the selective association at the second wireless communication device is enabled or disabled, and a set of the one or more STAs allowed to associate with the second wireless communication device is associated with whether the selective association at the second wireless communication device is enabled or disabled.
Clause 21: The method of any of clauses 19-20, where the information element includes an indication of a quantity of the one or more STAs allowed to associate with the second wireless communication device.
Clause 22: The method of any of clauses 19-21, where the information element includes a set of multiple fields, and the set of multiple fields includes a first field that indicates whether the selective association at the second wireless communication device is enabled or disabled; a second field that indicates a quantity of the one or more STAs allowed to associate with the second wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the second wireless communication device.
Clause 23: The method of clause 22, where the first field includes a first quantity of bits that indicates whether the selective association at the second wireless communication device is enabled or disabled; the second field includes a second quantity of bits that indicates the quantity of the one or more STAs allowed to associate with the second wireless communication device; and each subfield of the one or more subfields within the third field includes a third quantity of bits that indicates the respective identifier of one or more identifiers.
Clause 24: The method of clause 23, where the first quantity of bits is one bit; the second quantity of bits is within an inclusive range of one bit and ten bits; and the third quantity of bits is 48 bits.
Clause 25: The method of any of clauses 19-24, further including: transmitting, in accordance with receiving the frame, a second frame includes a second information element indicative of the selective association at the second wireless communication device, where the second information element includes the indication of the one or more STAs allowed to associate with the second wireless communication device.
Clause 26: The method of any of clauses 19-25, where the frame that includes the information element indicative of the selective association at the second wireless communication device is received from the second wireless communication device or a central controller of the multi-AP association.
Clause 27: The method of any of clauses 19-26, further including: communicating a second set of frames in association with switching a first data path between a STA and the first wireless communication device to a second data path between the STA and the second wireless communication device in accordance with the selective association at the second wireless communication device.
Clause 28: The method of clause 27, further including: communicating a third set of frames associated with a context transfer of the STA from the first wireless communication device to the second wireless communication device in accordance with the selective association at the second wireless communication device, where communicating the second set of frames is in accordance with communicating the third set of frames associated with the context transfer.
Clause 29: The method of clause 28, where communicating one or both of the second set of frames and the third set of frames is in association with the one or more STAs allowed to associate with the second wireless communication device including the STA.
Clause 30: The method of any of clauses 19-29, where the selective association at the second wireless communication device is in accordance with the second wireless communication device operating as a mobile AP, a traffic load restriction at the second wireless communication device, a traffic type restriction at the second wireless communication device, a client type restriction at the second wireless communication device, a user restriction at the second wireless communication device, or any combination thereof.
Clause 31: The method of any of clauses 19-30, where each of the first wireless communication device and the second wireless communication device is associated with a respective set of links of an SMD MLD in accordance with the multi-AP association between the first wireless communication device and the second wireless communication device.
Clause 32: The method of any of clauses 19-31, where the frame is a management frame.
Clause 33: The method of clause 32, where the management frame is a beacon frame.
Clause 34: A method for wireless communication at a STA, including: receiving a frame that includes an information element indicative of a selective association at a first AP, where the information element includes an indication of one or more STAs allowed to associate with the first AP; and selectively transmitting a first set of frames to the first AP in accordance with the selective association at the first AP.
Clause 35: The method of clause 34, further including: communicating a second set of frames in association with establishing one or more data paths between the STA and an SMD MLD in accordance with the selective association at the first AP, where the SMD MLD is associated with a set of multiple APs, and where the set of multiple APs includes the first AP in accordance with the one or more STAs allowed to associate with the first AP including the STA; or excludes the first AP in accordance with the one or more STAs allowed to associate with the first AP excluding the STA.
Clause 36: The method of any of clauses 34-35, where the information element includes an indication of whether the selective association at the first AP is enabled or disabled, and a set of the one or more STAs allowed to associate with the first AP is associated with whether the selective association at the first AP is enabled or disabled.
Clause 37: The method of any of clauses 34-36, where the information element includes an indication of a quantity of the one or more STAs allowed to associate with the first AP.
Clause 38: The method of any of clauses 34-37, where the information element includes a set of multiple fields, and the set of multiple fields includes a first field that indicates whether the selective association at the first AP is enabled or disabled; a second field that indicates a quantity of the one or more STAs allowed to associate with the first AP; and a third field that includes one or more subfields, each subfield of the one or more subfields indicating a respective identifier of one or more identifiers, each identifier of the one or more identifiers corresponding to a respective STA of the one or more STAs allowed to associate with the first AP.
Clause 39: The method of clause 38, where the first field includes a first quantity of bits that indicate whether the selective association at the first AP is enabled or disabled; the second field includes a second quantity of bits that indicates the quantity of the one or more STAs allowed to associate with the first AP; and each subfield of the one or more subfields within the third field includes a third quantity of bits that indicates the respective identifier of one or more identifiers.
Clause 40: The method of clause 39, where the first quantity of bits is one bit; the second quantity of bits is within an inclusive range of one bit and ten bits; and the third quantity of bits is 48 bits.
Clause 41: The method of any of clauses 34-40, where selectively transmitting the first set of frames to the first AP includes: transmitting the first set of frames in accordance with the one or more STAs allowed to associate with the first AP including the STA; or refraining from transmitting the first set of frames in accordance with the one or more STAs allowed to associate with the first AP excluding the STA.
Clause 42: The method of any of clauses 34-41, where the first set of frames includes an association frame, a probe request frame, a data frame, or any combination thereof.
Clause 43: The method of any of clauses 34-42, where the selective association at the first AP is in accordance with the first AP operating as a mobile AP, a traffic load restriction at the first AP, a traffic type restriction at the first AP, a client type restriction at the first AP, a user restriction at the first AP, or any combination thereof.
Clause 44: The method of any of clauses 34-43, where the frame is a management frame.
Clause 45: The method of clause 44, where the management frame is a beacon frame.
Clause 46: A method for wireless communication at a central controller, including: establishing a multi-AP association between at least a first wireless communication device and a second wireless communication device; and transmitting, in accordance with the establishment of the multi-AP association between at least the first wireless communication device and the second wireless communication device, information indicative of a selective association at the first wireless communication device, where the information includes an indication of one or more STAs allowed to associate with the first wireless communication device.
Clause 47: The method of clause 46, where the selective association at the first wireless communication device is in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.
Clause 48: The method of any of clauses 46-47, where each of the first wireless communication device and the second wireless communication device is associated with a respective set of links of an SMD MLD in accordance with the multi-AP association between the first wireless communication device and the second wireless communication device.
Clause 49: A first wireless communication device, including: a processing system that includes processor circuitry and memory circuitry that stores code, the processing system configured to cause the first wireless communication device to: communicate a first set of frames associated with an establishment of a multi-AP association between the first wireless communication device and at least a second wireless communication device; and transmit, in accordance with the establishment of the multi-AP association between the first wireless communication device and at least the second wireless communication device, a frame that includes an information element indicative of a selective association at the first wireless communication device, where the information element includes an indication of one or more STAs allowed to associate with the first wireless communication device.
Clause 50: The first wireless communication device of clause 49, where the processing system is further configured to cause the first wireless communication device to: selectively associate with a set of STAs in accordance with the selective association at the first wireless communication device, where the set of STAs includes at least a subset of the one or more STAs allowed to associate with the first wireless communication device.
Clause 51: The first wireless communication device of any of clauses 49-50, where the information element includes an indication of whether the selective association at the first wireless communication device is enabled or disabled, and a set of the one or more STAs allowed to associate with the first wireless communication device is associated with whether the selective association at the first wireless communication device is enabled or disabled.
Clause 52: The first wireless communication device of any of clauses 49-51, where the information element includes an indication of a quantity of the one or more STAs allowed to associate with the first wireless communication device.
Clause 53: The first wireless communication device of any of clauses 49-52, where the information element includes a set of multiple fields, and the set of multiple fields includes a first field that indicates whether the selective association at the first wireless communication device is enabled or disabled; a second field that indicates a quantity of the one or more STAs allowed to associate with the first wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the first wireless communication device.
Clause 54: The first wireless communication device of clause 53, where the first field includes a first quantity of bits that indicate whether the selective association at the first wireless communication device is enabled or disabled; the second field includes a second quantity of bits that indicate the quantity of the one or more STAs allowed to associate with the first wireless communication device; and each subfield of the one or more subfields within the third field includes a third quantity of bits that indicate the respective identifier of one or more identifiers.
Clause 55: The first wireless communication device of clause 54, where the first quantity of bits is one bit; the second quantity of bits is within an inclusive range of one bit and ten bits; and the third quantity of bits is 48 bits.
Clause 56: The first wireless communication device of any of clauses 49-55, where the processing system is further configured to cause the first wireless communication device to: receive information indicative of the selective association at the first wireless communication device, where transmitting the frame that includes the information element indicative of the selective association at the first wireless communication device is in accordance with receiving the information indicative of the selective association at the first wireless communication device.
Clause 57: The first wireless communication device of clause 56, where the information indicative of the selective association at the first wireless communication device is received from a central controller of the multi-AP association.
Clause 58: The first wireless communication device of any of clauses 49-57, where the processing system is further configured to cause the first wireless communication device to: communicate a second set of frames in association with switching a first data path between a STA and the second wireless communication device to a second data path between the STA and the first wireless communication device in accordance with the selective association at the first wireless communication device.
Clause 59: The first wireless communication device of clause 58, where the processing system is further configured to cause the first wireless communication device to: communicate a third set of frames associated with a context transfer of the STA from the second wireless communication device to the first wireless communication device in accordance with the selective association at the first wireless communication device, where communicating the second set of frames is in accordance with communicating the third set of frames associated with the context transfer.
Clause 60: The first wireless communication device of clause 59, where communicating one or both of the second set of frames and the third set of frames is in association with the one or more STAs allowed to associate with the first wireless communication device including the STA.
Clause 61: The first wireless communication device of any of clauses 49-60, where the first wireless communication device prohibits a switching from a first data path between a STA and the second wireless communication device to a second data path between the STA and the first wireless communication device in accordance with the selective association at the first wireless communication device.
Clause 62: The first wireless communication device of clause 61, where the first wireless communication device prohibits the switching from the first data path to the second data path in association with the one or more STAs allowed to associate with the first wireless communication device excluding the STA.
Clause 63: The first wireless communication device of any of clauses 49-62, where the selective association at the first wireless communication device is in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.
Clause 64: The first wireless communication device of any of clauses 49-63, where each of the first wireless communication device and the second wireless communication device is associated with a respective set of links of an SMD MLD in accordance with the multi-AP association between the first wireless communication device and the second wireless communication device.
Clause 65: The first wireless communication device of any of clauses 49-64, where the frame is a management frame.
Clause 66: The first wireless communication device of clause 65, where the management frame is a beacon frame.
Clause 67: A first wireless communication device, including: a processing system that includes processor circuitry and memory circuitry that stores code, the processing system configured to cause the first wireless communication device to: communicate a first set of frames associated with an establishment of a multi-AP association between the first wireless communication device and at least a second wireless communication device; and receive, in accordance with the establishment of the multi-AP association between the first wireless communication device and at least the second wireless communication device, a frame that includes an information element indicative of a selective association at the second wireless communication device, where the information element includes an indication of one or more STAs allowed to associate with the second wireless communication device.
Clause 68: The first wireless communication device of clause 67, where the information element includes an indication of whether the selective association at the second wireless communication device is enabled or disabled, and a set of the one or more STAs allowed to associate with the second wireless communication device is associated with whether the selective association at the second wireless communication device is enabled or disabled.
Clause 69: The first wireless communication device of any of clauses 67-68, where the information element includes an indication of a quantity of the one or more STAs allowed to associate with the second wireless communication device.
Clause 70: The first wireless communication device of any of clauses 67-69, where the information element includes a set of multiple fields, and the set of multiple fields includes a first field that indicates whether the selective association at the second wireless communication device is enabled or disabled; a second field that indicates a quantity of the one or more STAs allowed to associate with the second wireless communication device; and a third field that includes one or more subfields, each subfield of the one or more subfields indicating a respective identifier of one or more identifiers, each identifier of the one or more identifiers corresponding to a respective STA of the one or more STAs allowed to associate with the second wireless communication device.
Clause 71: The first wireless communication device of clause 70, where the first field includes a first quantity of bits that indicates whether the selective association at the second wireless communication device is enabled or disabled; the second field includes a second quantity of bits that indicates the quantity of the one or more STAs allowed to associate with the second wireless communication device; and each subfield of the one or more subfields within the third field includes a third quantity of bits that indicates the respective identifier of one or more identifiers.
Clause 72: The first wireless communication device of clause 71, where the first quantity of bits is one bit; the second quantity of bits is within an inclusive range of one bit and ten bits; and the third quantity of bits is 48 bits.
Clause 73: The first wireless communication device of any of clauses 67-72, where the processing system is further configured to cause the first wireless communication device to: transmit, in accordance with receiving the frame, a second frame includes a second information element indicative of the selective association at the second wireless communication device, where the second information element includes the indication of the one or more STAs allowed to associate with the second wireless communication device.
Clause 74: The first wireless communication device of any of clauses 67-73, where the frame that includes the information element indicative of the selective association at the second wireless communication device is received from the second wireless communication device or a central controller of the multi-AP association.
Clause 75: The first wireless communication device of any of clauses 67-74, where the processing system is further configured to cause the first wireless communication device to: communicate a second set of frames in association with switching a first data path between a STA and the first wireless communication device to a second data path between the STA and the second wireless communication device in accordance with the selective association at the second wireless communication device.
Clause 76: The first wireless communication device of clause 75, where the processing system is further configured to cause the first wireless communication device to: communicate a third set of frames associated with a context transfer of the STA from the first wireless communication device to the second wireless communication device in accordance with the selective association at the second wireless communication device, where communicating the second set of frames is in accordance with communicating the third set of frames associated with the context transfer.
Clause 77: The first wireless communication device of clause 76, where communicating one or both of the second set of frames and the third set of frames is in association with the one or more STAs allowed to associate with the second wireless communication device including the STA.
Clause 78: The first wireless communication device of any of clauses 67-77, where the selective association at the second wireless communication device is in accordance with the second wireless communication device operating as a mobile AP, a traffic load restriction at the second wireless communication device, a traffic type restriction at the second wireless communication device, a client type restriction at the second wireless communication device, a user restriction at the second wireless communication device, or any combination thereof.
Clause 79: The first wireless communication device of any of clauses 67-78, where each of the first wireless communication device and the second wireless communication device is associated with a respective set of links of an SMD MLD in accordance with the multi-AP association between the first wireless communication device and the second wireless communication device.
Clause 80: The first wireless communication device of any of clauses 67-79, where the frame is a management frame.
Clause 81: The first wireless communication device of clause 80, where the management frame is a beacon frame.
Clause 82: A STA, including: a processing system that includes processor circuitry and memory circuitry that stores code, the processing system configured to cause the STA to: receive a frame that includes an information element indicative of a selective association at a first AP, where the information element includes an indication of one or more STAs allowed to associate with the first AP; and selectively transmit a first set of frames to the first AP in accordance with the selective association at the first AP.
Clause 83: The STA of clause 82, where the processing system is further configured to cause the STA to: communicate a second set of frames in association with establishing one or more data paths between the STA and an SMD MLD in accordance with the selective association at the first AP, where the SMD MLD is associated with a set of multiple APs, and where the set of multiple APs includes the first AP in accordance with the one or more STAs allowed to associate with the first AP including the STA; or excludes the first AP in accordance with the one or more STAs allowed to associate with the first AP excluding the STA.
Clause 84: The STA of any of clauses 82-83, where the information element includes an indication of whether the selective association at the first AP is enabled or disabled, and a set of the one or more STAs allowed to associate with the first AP is associated with whether the selective association at the first AP is enabled or disabled.
Clause 85: The STA of any of clauses 82-84, where the information element includes an indication of a quantity of the one or more STAs allowed to associate with the first AP.
Clause 86: The STA of any of clauses 82-85, where the information element includes a set of multiple fields, and the set of multiple fields includes a first field that indicates whether the selective association at the first AP is enabled or disabled; a second field that indicates a quantity of the one or more STAs allowed to associate with the first AP; and a third field that includes one or more subfields, each subfield of the one or more subfields indicating a respective identifier of one or more identifiers, each identifier of the one or more identifiers corresponding to a respective STA of the one or more STAs allowed to associate with the first AP.
Clause 87: The STA of clause 86, where the first field includes a first quantity of bits that indicate whether the selective association at the first AP is enabled or disabled; the second field includes a second quantity of bits that indicates the quantity of the one or more STAs allowed to associate with the first AP; and each subfield of the one or more subfields within the third field includes a third quantity of bits that indicates the respective identifier of one or more identifiers.
Clause 88: The STA of clause 87, where the first quantity of bits is one bit; the second quantity of bits is within an inclusive range of one bit and ten bits; and the third quantity of bits is 48 bits.
Clause 89: The STA of any of clauses 82-88, where, to selectively transmit the first set of frames to the first AP, the processing system is configured to cause the STA to: transmit the first set of frames in accordance with the one or more STAs allowed to associate with the first AP including the STA; or refrain from transmitting the first set of frames in accordance with the one or more STAs allowed to associate with the first AP excluding the STA.
Clause 90: The STA of any of clauses 82-89, where the first set of frames includes an association frame, a probe request frame, a data frame, or any combination thereof.
Clause 91: The STA of any of clauses 82-90, where the selective association at the first AP is in accordance with the first AP operating as a mobile AP, a traffic load restriction at the first AP, a traffic type restriction at the first AP, a client type restriction at the first AP, a user restriction at the first AP, or any combination thereof.
Clause 92: The STA of any of clauses 82-91, where the frame is a management frame.
Clause 93: The STA of clause 92, where the management frame is a beacon frame.
Clause 94: A central controller, including: a processing system that includes processor circuitry and memory circuitry that stores code, the processing system configured to cause the central controller to: establish a multi-AP association between at least a first wireless communication device and a second wireless communication device; and transmit, in accordance with the establishment of the multi-AP association between at least the first wireless communication device and the second wireless communication device, information indicative of a selective association at the first wireless communication device, where the information includes an indication of one or more STAs allowed to associate with the first wireless communication device.
Clause 95: The central controller of clause 94, where the selective association at the first wireless communication device is in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.
Clause 96: The central controller of any of clauses 94-95, where each of the first wireless communication device and the second wireless communication device is associated with a respective set of links of an SMD MLD in accordance with the multi-AP association between the first wireless communication device and the second wireless communication device.
Clause 97: A first wireless communication device, including at least one means for performing a method of any of clauses 1-18.
Clause 98: A non-transitory computer-readable medium storing code for wireless communication, the code including instructions executable by a processing system to perform a method of any of clauses 1-18.
Clause 99: A first wireless communication device, including at least one means for performing a method of any of clauses 19-33.
Clause 100: A non-transitory computer-readable medium storing code for wireless communication, the code including instructions executable by a processing system to perform a method of any of clauses 19-33.
Clause 101: A STA, including at least one means for performing a method of any of clauses 34-45.
Clause 102: A non-transitory computer-readable medium storing code for wireless communication, the code including instructions executable by a processing system to perform a method of any of clauses 34-45.
Clause 103: A central controller, including at least one means for performing a method of any of clauses 46-48.
Clause 104: A non-transitory computer-readable medium storing code for wireless communication, the code including instructions executable by a processing system to perform a method of any of clauses 46-48.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can, in some implementations, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A first wireless communication device, comprising:
a processing system that includes processor circuitry and memory circuitry that stores code, the processing system configured to cause the first wireless communication device to:
communicate a first set of frames associated with an establishment of a multi-access point (AP) association between the first wireless communication device and at least a second wireless communication device; and
transmit, in accordance with the establishment of the multi-AP association between the first wireless communication device and at least the second wireless communication device, a frame that includes an information element indicative of a selective association at the first wireless communication device, wherein the information element includes an indication of one or more stations (STAs) allowed to associate with the first wireless communication device.

2. The first wireless communication device of claim 1, wherein the processing system is further configured to cause the first wireless communication device to:
selectively associate with a set of STAs in accordance with the selective association at the first wireless communication device, wherein the set of STAs includes at least a subset of the one or more STAs allowed to associate with the first wireless communication device.

3. The first wireless communication device of claim 1, wherein:
the information element includes an indication of whether the selective association at the first wireless communication device is enabled or disabled; and
a set of the one or more STAs allowed to associate with the first wireless communication device is associated with whether the selective association at the first wireless communication device is enabled or disabled.

4. The first wireless communication device of claim 1, wherein the information element includes an indication of a quantity of the one or more STAs allowed to associate with the first wireless communication device.

5. The first wireless communication device of claim 1, wherein the information element includes a plurality of fields, and wherein the plurality of fields includes:
a first field that indicates whether the selective association at the first wireless communication device is enabled or disabled;
a second field that indicates a quantity of the one or more STAs allowed to associate with the first wireless communication device; and
a third field that includes one or more subfields, each subfield of the one or more subfields indicating a respective identifier of one or more identifiers, each identifier of the one or more identifiers corresponding to a respective STA of the one or more STAs allowed to associate with the first wireless communication device.

6. The first wireless communication device of claim 5, wherein:
the first field includes a first quantity of bits that indicate whether the selective association at the first wireless communication device is enabled or disabled;
the second field includes a second quantity of bits that indicate the quantity of the one or more STAs allowed to associate with the first wireless communication device; and
each subfield of the one or more subfields within the third field includes a third quantity of bits that indicate the respective identifier of one or more identifiers.

7. (canceled)

8. The first wireless communication device of claim 1, wherein the processing system is further configured to cause the first wireless communication device to:
receive information indicative of the selective association at the first wireless communication device, wherein transmitting the frame that includes the information element indicative of the selective association at the first wireless communication device is in accordance with receiving the information indicative of the selective association at the first wireless communication device.

9. The first wireless communication device of claim 8, wherein the information indicative of the selective association at the first wireless communication device is received from a central controller of the multi-AP association.

10. The first wireless communication device of claim 1, wherein the processing system is further configured to cause the first wireless communication device to:
communicate a second set of frames in association with switching a first data path between a STA and the second wireless communication device to a second data path between the STA and the first wireless communication device in accordance with the selective association at the first wireless communication device.

11. The first wireless communication device of claim 10, wherein the processing system is further configured to cause the first wireless communication device to:
communicate a third set of frames associated with a context transfer of the STA from the second wireless communication device to the first wireless communication device in accordance with the selective association at the first wireless communication device, wherein communicating the second set of frames is in accordance with communicating the third set of frames associated with the context transfer.

12. The first wireless communication device of claim 11, wherein communicating one or both of the second set of frames and the third set of frames is in association with the one or more STAs allowed to associate with the first wireless communication device including the STA.

13. The first wireless communication device of claim 1, wherein the first wireless communication device prohibits a switching from a first data path between a STA and the second wireless communication device to a second data path between the STA and the first wireless communication device in accordance with the selective association at the first wireless communication device.

14. The first wireless communication device of claim 13, wherein the first wireless communication device prohibits the switching from the first data path to the second data path in association with the one or more STAs allowed to associate with the first wireless communication device excluding the STA.

15. The first wireless communication device of claim 1, wherein the selective association at the first wireless communication device is in accordance with the first wireless communication device operating as a mobile AP, a traffic load restriction at the first wireless communication device, a traffic type restriction at the first wireless communication device, a client type restriction at the first wireless communication device, a user restriction at the first wireless communication device, or any combination thereof.

16-33. (canceled)

34. A station (STA), comprising:
a processing system that includes processor circuitry and memory circuitry that stores code, the processing system configured to cause the STA to:
receive a frame that includes an information element indicative of a selective association at a first access point (AP), wherein the information element includes an indication of one or more STAs allowed to associate with the first AP; and
selectively transmit a first set of frames to the first AP in accordance with the selective association at the first AP.

35. The STA of claim 34, wherein the processing system is further configured to cause the STA to:
communicate a second set of frames in association with establishing one or more data paths between the STA and a single mobility domain (SMD) multi-link device (MLD) in accordance with the selective association at the first AP, wherein the SMD MLD is associated with a plurality of APs, and wherein the plurality of APs:
includes the first AP in accordance with the one or more STAs allowed to associate with the first AP including the STA; or
excludes the first AP in accordance with the one or more STAs allowed to associate with the first AP excluding the STA.

36. The STA of claim 34, wherein:
the information element includes an indication of whether the selective association at the first AP is enabled or disabled; and
a set of the one or more STAs allowed to associate with the first AP is associated with whether the selective association at the first AP is enabled or disabled.

37. The STA of claim 34, wherein the information element includes an indication of a quantity of the one or more STAs allowed to associate with the first AP.

38. The STA of claim 34, wherein the information element includes a plurality of fields, and wherein the plurality of fields includes:
a first field that indicates whether the selective association at the first AP is enabled or disabled;
a second field that indicates a quantity of the one or more STAs allowed to associate with the first AP; and
a third field that includes one or more subfields, each subfield of the one or more subfields indicating a respective identifier of one or more identifiers, each identifier of the one or more identifiers corresponding to a respective STA of the one or more STAs allowed to associate with the first AP.

39. (canceled)

40. (canceled)

41. The STA of claim 34, wherein, to selectively transmit the first set of frames to the first AP, the processing system is configured to cause the STA to:
transmit the first set of frames in accordance with the one or more STAs allowed to associate with the first AP including the STA; or
refrain from transmitting the first set of frames in accordance with the one or more STAs allowed to associate with the first AP excluding the STA.

42-48. (canceled)

49. A method for wireless communication at a first wireless communication device, comprising:
communicating a first set of frames associated with an establishment of a multi-access point (AP) association between the first wireless communication device and at least a second wireless communication device; and
transmitting, in accordance with the establishment of the multi-AP association between the first wireless communication device and at least the second wireless communication device, a frame that includes an information element indicative of a selective association at the first wireless communication device, wherein the information element includes an indication of one or more stations (STAs) allowed to associate with the first wireless communication device.

50. The method of claim 49, further comprising:
selectively associating with a set of STAs in accordance with the selective association at the first wireless communication device, wherein the set of STAs includes at least a subset of the one or more STAs allowed to associate with the first wireless communication device.

51. (canceled)

52. (canceled)

53. The method of claim 49, wherein the information element includes a plurality of fields, and wherein the plurality of fields includes:
a first field that indicates whether the selective association at the first wireless communication device is enabled or disabled;
a second field that indicates a quantity of the one or more STAs allowed to associate with the first wireless communication device; and
a third field that includes one or more subfields, each subfield of the one or more subfields indicating a respective identifier of one or more identifiers, each identifier of the one or more identifiers corresponding to a respective STA of the one or more STAs allowed to associate with the first wireless communication device.

54. The method of claim 53, wherein:
the first field includes a first quantity of bits that indicate whether the selective association at the first wireless communication device is enabled or disabled;
the second field includes a second quantity of bits that indicate the quantity of the one or more STAs allowed to associate with the first wireless communication device; and
each subfield of the one or more subfields within the third field includes a third quantity of bits that indicate the respective identifier of one or more identifiers.

55-63. (canceled)

64. The method of claim 49, wherein each of the first wireless communication device and the second wireless communication device is associated with a respective set of links of a single mobility domain (SMD) multi-link device (MLD) in accordance with the multi-AP association between the first wireless communication device and the second wireless communication device.

65. The method of claim 49, wherein the frame is a management frame.

66-81. (canceled)

82. A method for wireless communication at a station (STA), comprising:
receiving a frame that includes an information element indicative of a selective association at a first access point (AP), wherein the information element includes an indication of one or more STAs allowed to associate with the first AP; and
selectively transmitting a first set of frames to the first AP in accordance with the selective association at the first AP.

83. The method of claim 82, further comprising:
communicating a second set of frames in association with establishing one or more data paths between the STA and a single mobility domain (SMD) multi-link device (MLD) in accordance with the selective association at the first AP, wherein the SMD MLD is associated with a plurality of APs, and wherein the plurality of APs:
includes the first AP in accordance with the one or more STAs allowed to associate with the first AP including the STA; or
excludes the first AP in accordance with the one or more STAs allowed to associate with the first AP excluding the STA.

84. (canceled)

85. (canceled)

86. The method of claim 82, wherein the information element includes a plurality of fields, and wherein the plurality of fields includes:
a first field that indicates whether the selective association at the first AP is enabled or disabled;
a second field that indicates a quantity of the one or more STAs allowed to associate with the first AP; and
a third field that includes one or more subfields, each subfield of the one or more subfields indicating a respective identifier of one or more identifiers, each identifier of the one or more identifiers corresponding to a respective STA of the one or more STAs allowed to associate with the first AP.

87. (canceled)

88. (canceled)

89. The method of claim 82, wherein selectively transmitting the first set of frames to the first AP comprises:
transmitting the first set of frames in accordance with the one or more STAs allowed to associate with the first AP including the STA; or
refraining from transmitting the first set of frames in accordance with the one or more STAs allowed to associate with the first AP excluding the STA.

90-96. (canceled)
